(19) United States
(12) Patent Application Publication
(10) Pub. No.: US 2026/0063888 A1
(43) Pub. Date: Mar. 5, 2026

(54) Microscope and Microscopy Method

(71) Applicant: Carl Zeiss Microscopy GmbH, Jena (DE)

(72) Inventors: Lars Loetgering, Jena (DE); Rainer Heintzmann, Jena (DE)

(21) Appl. No.: 19/308,150

(22) Filed: Aug. 22, 2025

(30) Foreign Application Priority Data
Aug. 29, 2024 (DE) 10 2024 124 763.0

(51) Int. Cl. G02B 21/36; G02B 21/06; G02B 21/26

(52) U.S. Cl. CPC G02B 21/365; G02B 21/06; G02B 21/26; G02B 21/361

(57) ABSTRACT

A microscope comprising a detector for detecting emission light emitted by a sample, a detection beam path comprising a microscope objective for guiding the emission light to the detector and a control unit configured for collecting and evaluating measurement data Cₖ from the detector. The control unit is configured for carrying out the following steps: a measurement data collection step wherein measurement data Cₖ are collected from the detector while the sample is sequentially illuminated with at least two different sample illumination patterns Jₖ and a sample information calculation step wherein a microscopic sample information S is calculated which minimizes or maximizes a scalar cost function L=D[ρ(Jₖ·S),ρ(Cₖ)], wherein ρ is a measure of statistical dispersion with respect to the sample illumination pattern index k, and D is a distance metric.

The current application claims the benefit of German Patent Application No. 10 2024 124 763.0, filed on 29 Aug. 2024, which is hereby incorporated by reference.

In a first aspect, the present invention is concerned with a microscope according to the preamble of claim 1. In a second aspect, the invention relates to a microscopy method according to the preamble of claim 29.

A generic microscope comprises a light source for supplying illumination light, an illumination beam path for guiding the illumination light to a sample space comprising at least one light manipulation device for generating at least one pattern of structured illumination light, a detector for detecting emission light emitted by a sample in the sample space, a detection beam path comprising a microscope objective for guiding the emission light to the detector and a control unit configured for collecting and evaluating measurement data from the detector.

A generic microscopy method comprises the following steps: illuminating a sample through an illumination beam path of a microscope with structured illumination light, guiding emission light emitted by the sample through a detection beam path comprising a microscope objective to a detector, detecting the emission light with the detector, and further comprising a measurement data collection step wherein measurement data are collected from the detector while the sample is sequentially illuminated with at least two different sample illumination patterns.

A generic microscope and a generic microscopy method are, e.g., disclosed in [12].

Known techniques that allow for optical sectioning comprise in particular confocal microscopy, structured illumination microscopy (SIM), light sheet microscopy, Dynamic Speckle Imaging (DSI), HiLo, and random illumination microscopy (RIM).

The oldest of these technologies is confocal microscopy where a pinhole in a detection-sided conjugated plane of a focal spot in a scanning microscope reduces out of focus blur.

Light sheet microscopy is another technique inherently enabling optical sectioning. There, a thin section of light, i.e., a light sheet, excites fluorescence within a specimen [3]. As circa of the year 2000, several computational wide field optical sectioning techniques were reported.

Dynamic Speckle Imaging (DSI), [4], projects a sequence of hundreds of speckle patterns onto a specimen. The out-of-focus structures from the specimen are blurred due to the extended size of the defocus detection point spread function (PSF). This causes out-of-focus structures to exhibit reduced variance when the pixels are individually counted over the sequence of captured images. Hence, simply computing the variance over the captured time series confers optical sectioning to DSI. Projecting and capturing hundreds of speckle patterns into the specimen is time-consuming, though. A variant of DSI using wavelet filtering was reported, [5], which improves contrast and reduces the number of acquisitions needed. This, however, comes at the cost of an increased computational burden. DSI seems to have been the first instance of explicitly computing the variance of a sequence of images to achieve optical sectioning. The main shortcoming of DSI is its ignorance of the illumination pattern. By design, it requires a sequence of speckle illuminations that have uniform variance, otherwise the speckle pattern imprint unwanted artefacts. Moreover, DSI requires many illumination patterns until the variance stabilizes to a fixed value.

Another optical sectioning microscopy technique has been reported by Lim et al. and is called HiLo, [7]. This technique acquires only two wide field images using a first uniform illumination and second a speckle illumination. The technique combines a weighted average of a high-pass filtered version of the uniform illumination image with a low-pass filtered version of the speckle-illuminated image to attain optical sectioning. The technique is licensed by Evident in the SILA optical sectioning device [8]. While HiLo is an attractive optical sectioning technique, it is numerically slower to process its data as compared to traditional SIM since Fourier transforms of the captured images must be used. In addition, the algorithm contains various parameters that must be tuned via optimization. Producing high-contrast speckle requires a laser source that adds to the hardware cost of the system.

Most recently, a form of blind SIM, termed random illumination microscopy (RIM) has been reported by Labouesse at al. [9,10]. There, unknown speckle patterns are used, allowing for both superresolution microscopy and optical sectioning. Like DSI, RIM requires the specimen to be illuminated with a sequence of hundreds of speckle patterns. An explicit deconvolution of the autocovariance function of the acquired time-series yields a superresolution and sectioned image of the specimen. Like DSI, RIM is agnostic of the illumination pattern exciting the specimen. It is for this reason that hundreds of images must be acquired until the autocovariance stabilizes sufficiently and allows for extracting a robust estimate of the specimen.

In the known structured illumination microscopy (SIM) technology as described, e.g., in [12], an absorption grating is placed within an intermediate image plane in the illumination beam path. The grating is, e.g., mounted on a movable actuator. The microscope can comprise an observer wide field system which contains a high-resolution translation stage. Wide field optical sectioning was first experimentally demonstrated in [1], where a grating was projected onto a specimen in an epi-microscope system. Three images were captured under lateral translation of the grating, enabling to process the raw data into an optically sectioned image. With presently available SIM-systems, a data analysis pipeline is incapable of modeling imperfections in both, the illumination path and the detection beam path, such as dust and scratches, e.g., on the grating or the camera. In addition, optical aberrations such as vignetting and field curvature may alter the appearance of the grating incident on the specimen. Optical aberrations in the detection beam path may also be present and can be detrimental to the performance of the system.

It can be considered an object of the present invention to specify a microscope and a microscopy method where improvements with respect to at least some of the aforementioned issues can be achieved.

This object is solved according to the invention by the microscope having the features of claim 1 and by the microscopy method having the features of claim 28. Preferred embodiments of the microscope according to the invention and advantageous variants of the microscopy method according to the invention will be described, in particular with reference to the dependent claims and the figures.

The generic microscope as described above is further developed according to the invention in that the control unit is configured for carrying out the following steps:
a measurement data collection step wherein measurement data Cₖ are collected from the detector while the sample is sequentially illuminated with at least two different sample illumination patterns Jₖ where each of the sample illumination patterns Jₖ comprises one of the patterns of structured illumination light and
a sample information calculation step wherein a microscopic sample information S is calculated which minimizes or maximizes a scalar cost function

L=D[ρ(Jₖ·S),ρ(Cₖ)], wherein
k is a sample illumination pattern index,
Jₖ is a sample illumination pattern,
Cₖ is the detector signal obtained for the sample illumination pattern Jₖ,
ρ is a measure of statistical dispersion with respect to the sample illumination pattern index k, and
D is a distance metric.

According to the invention, the generic microscopy method as described above is further characterized in a sample information calculation step wherein a microscopic sample information S is calculated which minimizes or maximizes a scalar cost function

L=D[ρJₖ·S),ρ(Cₖ)], wherein
k is a sample illumination pattern index,
Jₖ is a sample illumination pattern,
Cₖ is the detector signal obtained for the sample illumination pattern Jₖ,
ρ is a measure of statistical dispersion with respect to the sample illumination pattern index k, and
D is a distance metric.

Preferred variants of the method according to the invention further comprise using the microscope according to the invention. The microscope and in particular the control unit can be configured for carrying out at least one of or all of the variants of the microscopy method according to the invention described herein.

The light source can in principle be any light source capable of providing the illumination light with a desired wavelength or desired wavelengths and with a suitable intensity. E.g., the light source can be a laser or an LED-module. The illumination light can in principle be coherent or at least partially coherent light. It can be considered an advantage of the present invention, though, that coherent light is not necessary for the microscope and the microscopy method according to the invention to work.

The Illumination light Is electromagnetic radiation, in particular in the visible spectral range and adjoining ranges. The only demand placed on the contrast-providing principle by the present invention is that the sample emits emission light as a consequence of the irradiation by the illumination light. The illumination light can also be termed excitation light and for the most part these two terms are used synonymously throughout this description. Light emitted by the sample to be examined as a consequence of the irradiation by the illumination or excitation light is referred to as emission light and reaches the detector, e.g., a camera, via the detection beam path.

The terms homogeneous illumination and homogeneous illumination profile are understood to mean an illumination profile that does not show any lateral dependencies of the light intensity over a beam section. I.e., the light intensity is constant in the lateral directions in a considered beam section. Correspondingly, an inhomogeneous illumination profile is an illumination profile where the light intensity is not constant in the lateral direction in a considered beam section.

For light to qualify as emission light it is only necessary that the light comes from the illuminated sample. Typically, the emission light can be fluorescence light which the sample, in particular dye molecules present there, emits or emit as a consequence of the irradiation by the excitation light. The emission light can also be either of reflected, transmitted, and scattered illumination light. The sample can also be termed a specimen. The sample can, in principle, be any kind of sample. The microscope and the method of the Invention are in particular suitable for the Investigation of biological samples.

The term illumination beam path denotes all optical beam-guiding and beam-modifying components, for example lenses, mirrors, prisms, gratings, filters, stops, beam splitters, by means of which and via which the illumination light is guided from a light source to the sample to be examined. The illumination beam path can comprise an illumination objective. The illumination objective and the microscope objective may be, in each case, microscope objectives of a type known per se. In principle, the illumination objective and the microscope objective can be separate objectives. In preferred embodiments, though, the illumination objective and the microscope objective are the same objective.

The term sample space denotes the spatial region where a sample to be investigated can be arranged. In preferred embodiments, the microscope comprises a mechanical drive for setting a relative lateral position between the sample and the microscope objective with respect to an optical axis of the microscope objective. The control unit can be configured for controlling the mechanical drive. In preferred embodiments, the sample can be placed or mounted, e.g., by means of a sample holder or a sample frame, on a stage which can be manipulated in lateral directions with respect to an optical axis with said mechanical drive. Furthermore, an axial drive can be present for varying a spacing between the sample, e.g., the sample stage, and the illumination objective or between the sample and the microscope objective. The mechanical drive and/or the axial drive can be mounted to a microscope stand. The microscope stand can be an upright as well as an inverse stand.

The terms structured illumination light or patterns of structured illumination light mean, in each case, illumination light downstream of the at least one light manipulating device. The fact that the illumination light has been manipulated or that it is structured means that at least spatial portions of a beam section of the illumination light have been changed with respect to at least one of amplitude and phase as compared to the incoming illumination light.

Thus, the at least one light manipulation device can be based on at least one of the optical effects of diffraction, at least partial absorption, imposition of phase shifts on the illumination light. The at least one light manipulation device can be an at least partially transmissive light manipulation device. It is also possible that the at least one light manipulation device is an at least partially reflective light manipulation device.

Otherwise, the only requirement placed on the used patterns for structured illumination light is that the structures need to be resolvable by the used microscope objective.

The term pupil plane refers to a plane, in particular perpendicular to the optical axis of the illumination beam path or the detection beam path, which is optically conjugate to a rear focal plane of the respective microscope objective. The term intermediate image plane refers to a plane, in particular a plane perpendicular to the optical axis of the illumination beam path or the detection beam path, which is optically conjugate to an image plane of the respective microscope objective.

When the present description refers to a component being located in a pupil plane or in an intermediate image plane, it always also means that the component in question is located in the vicinity of the respective pupil plane or in the vicinity of the respective intermediate image plane. This is already clear in itself because neither the pupil planes nor the intermediate image planes are planes in a mathematical sense. Also, the respective components, e.g., an SLM or a grating, in each case have a finite extension in the direction of the optical axis.

In principle, it is possible to arrange a light manipulation device in a pupil plane or in the vicinity of a pupil plane. Then, at least partially coherent illumination light, e.g., from a laser, is necessary. Also, it might then be necessary that the illumination beam path comprises a telescope optics for providing a pupil plane.

In a preferred embodiment of the microscope according to the invention, the at least one light manipulation device is arranged in an intermediate image plane or in the vicinity of an intermediate image plane. Then, the manipulation or structuring takes place in a plane conjugate to a sample plane and the excitation light may be either coherent or incoherent.

In preferred embodiments of the microscope according to the invention, the light manipulation device comprises at least one controllable light manipulation element for generating different patterns of structured illumination light. The control unit can be configured for controlling the light manipulation device. The controllable light manipulation element can comprise at least one of: grating which is at least laterally adjustable in the illumination beam path, spatial light modulator (SLM), digital micromirror device (DMD). The grating can also be axially movable. In the case of a partially coherent illumination this can be used to optimize contrast. The spatial light modulator can be at least one of an amplitude modulating spatial light modulator and a phase modulating spatial light modulator. Generally, phase modulating spatial light modulators are preferred in consideration of their lower light losses. The spatial light modulator can be a reflective spatial light modulator or a transmissive spatial light modulator.

The term sample illumination pattern Jₖ means one of the patterns of structured illumination light in its spatial relation to the sample. Different sample illumination patterns Jₖ carry a different sample illumination pattern index k, where k is an integer or zero. I.e., the same pattern of structured illumination light can produce different sample illumination patterns Jₖ. Where the pattern of structured illumination light is fixed, the sample illumination patterns Jₖ differ only in the spatial relation of the sample with respect to the pattern of structured illumination light. As will become apparent further below, the term pattern of structured illumination light is understood as the image of the pattern as imaged, e.g., by a camera, when a structureless sample is illuminated with the respective pattern of structured illumination light. I.e., a pattern of structured illumination light includes in reality effects of vignetting in the illumination or detection beam path as well as, e.g., specks or scratches on a grating and/or specks on a camera used as the detector.

Generally, it is possible to change the sample illumination pattern Jₖ by changing the pattern of structured illumination light. In a preferred embodiment of the microscope according to the invention, the control unit is configured for changing the illumination pattern Jₖ by changing a setting for the controllable light manipulation element so as to produce a different pattern of structured illumination light. E.g., a lateral position of a grating in the illumination beam path can be changed or a spatial light modulator can be set to a different spatial light modulation pattern.

It is also possible, and in many cases preferable, that the pattern of structured illumination light remains unchanged and that the sample illumination pattern Jₖ is changed by changing a spatial relation between the sample and the respective pattern of structured illumination light. This can, e.g., be brought about by changing a relative lateral position between the sample and the microscope objective with respect to an optical axis of the microscope objective. In a preferred embodiment of the microscope according to the invention, the control unit is configured for changing the sample illumination pattern Jₖ by changing a setting of the mechanical drive to a changed relative lateral position between the sample and the microscope objective with respect to an optical axis of the microscope objective.

For standard SIM, it is necessary that averaged over the different sample illumination patterns Jₖ the illumination of the sample be homogeneous. For the present invention, this is only a possibility, i.e., averaged over the different sample illumination patterns Jₖ the illumination of the sample can be homogeneous. It can be considered an important advantage of the present invention, though, that this is not necessary. I.e., in preferred embodiments of the invention, averaged over the different sample illumination patterns Jₖ the illumination of the sample is inhomogeneous, i.e. allowing for a spatially varying average excitation profile.

For standard SIM, it is necessary that the sample illumination patterns are periodic illumination patterns. While this possibility is retained with the present invention, it is not a necessity. I.e., in preferred embodiments of the invention, at least one of the sample illumination patterns Jₖ is an aperiodic illumination pattern. E.g., at least one or all of the sample illumination patterns/k can contain a one dimensional or a two-dimensional barcode.

The term detection beam path denotes all beam-guiding and beam-modifying optical components, for example lenses, mirrors, prisms, gratings, filters, stops, beam splitters, by means of which and via which the emission light is guided from the sample to be examined as far as the camera. Expediently, a sensor plane of the detector can be arranged in a plane which is optically conjugate to a focal plane of the microscope objective.

The field of view of the detection beam path denotes the lateral spatial portion in a sample plane from which emission light can be gathered and propagated to the detector. A size of a field of view is typically determined by the optical parameters, e.g., numerical aperture and magnification, of the microscope objective and further components in the detection beam path, e.g., a tube lens.

The type of detector for detecting the emission light being used depends generally from the type of microscope. In embodiments of the invention, the detector can comprise a two-dimensionally spatially resolving photodetector, e.g., a camera, a one-dimensionally spatially resolving detector, e.g., a linear detector array, or a single photodetector, e.g., a dot-like photodetector. More specifically, the detector can comprise at least one of the following: CCD-element, CMOS-element, SPAD-element, photomultiplier tube (PMT). In cases where the detector is not two-dimensionally spatially resolving, a line-scanner is necessary in the detection beam path in the case of a one dimensionally resolving detector and a two-dimensional scanner is necessary in the detection beam path in the case of a dot-like detector.

The term control unit denotes all hardware and software components which interact with the components of the microscope according to the invention for the intended functionality of the latter. In particular, the control unit can have a computing device, for example a PC, and a camera controller capable of reading out measurement signals. Measurement data from the detector are the measurement data produced by the detector upon Irradiation with emission light. The measurement data Cₖ are the measurement data from the detector while the sample is illuminated with the kth illumination pattern illumination pattern Jₖ.

A first important realization for the present invention was that traditional SIM is nonlinear in the observed data. For example, one traditional implementation of SIM to achieve optical sectioning was reported by Neil et al., [1], where the specimen is illuminated by a sequence of three sinusoidal modulations

$${J}_{k} ( x ) = \frac{1}{2} [ 1 + cos ( 2 π [ \frac{x}{p} - \frac{k - 1}{K} ] ) ] , k = 0 , 1 , 2 ; x = ( {x}_{1} , {x}_{2} )$$

These three illumination patterns yield three sets of measurement data Cₖ=Cₖ(x) which are converted into a specimen SIM image S_{SIM}(x) via nonlinear processing:

$${S}_{SIM} ( x ) = \sqrt{{( {C}_{0} - {C}_{1} )}^{2} + {( {C}_{1} - {C}_{2} )}^{2} + {( {C}_{2} - {C}_{0} )}^{2}} ,$$

where the dependence on x=(x₁, x₂) inside the parentheses has been dropped for notational convenience. It can be shown that this type of processing is proportional to computing the standard deviation

$${S}_{SIM} ( x ) ∼ \sqrt{{( {C}_{0} - μ )}^{2} + {( {C}_{1} - μ )}^{2} + {( {C}_{2} - μ )}^{2}} , \\ where μ ( x ) = \frac{1}{K} {\sum }_{k = 1}^{K} {C}_{k}$$

is the mean of the observations.

Linear processing as per the mean μ(x) yields a wide field specimen image having no sectioning properties, while nonlinear processing as per the standard deviation S_{SIM}(x) yields a sectioned specimen image. A prerequisite for the equation for S_{SIM} to be valid is that the sum of the illumination patterns is homogeneous, i.e.,

$$\frac{1}{K} {\sum }_{k = 1}^{K} {J}_{k} ( x ) = constant .$$

This assumption may not hold in practice, for example in wide field systems with large field of view and vignetting in the illumination, or illumination patterns generated from masks, which assemble dust and scratches over time. In such circumstances, the traditional SIM model is overly simple.

An important insight of the invention now considers the idea that the processing scheme for SIM can be generalized to the situations where the illumination pattern is not homogeneous on average.

A further important idea of the invention is then, that the microscopic sample information S can be obtained by minimizing or maximizing the scalar cost function

$$L = D [ ρ ( {J}_{k} \cdot S ) , ρ ( {C}_{k} ) ] .$$

Herein, at this stage, it is assumed that the sample illumination patterns Jₖ as such are known.

In principle, it is possible, to measure or calibrate the used patterns of structured illumination light beforehand, e.g., by measuring the response from a structureless sample when a sample is illuminated with the respective pattern of structured illumination light. Further below, preferred embodiments of the invention will be described where the at least one pattern of structured illumination light and thus the sample illumination patterns Jₖ can be elegantly determined using the invention described in the recently filed German patent application 10 2024 124 248.5 from the same applicant.

The microscopic sample information S being determined with the microscope and by the microscopy method according to the invention can also be termed sectioned microscopic sample information. The properties of the microscope and the microscopy method according to the invention yielding sectioned microscopic sample information S will be described and will become apparent in the following.

In preferred embodiments of the invention, the standard mean deviation σ is used as the measure of statistical dispersion p. In alternative embodiments of the invention, one of the following measures can be used as the measure of statistical dispersion p:
mean absolute deviation from the median (MAD),
measure of statistical dispersion based on an entropy calculated along an illumination pattern index, wherein the entropy is one of the Shannon-Entropy, the Jensen-Shannon-Divergence, the Renyi-Entropy, the Tsallis-Entropy,
one of the robust variance measures described in reference [11],
one of the variance measures contained in the equations 1. to 5., 6a., 6b., 7a., 7b. in the box in the left column on page 269, of reference [12].

In preferred embodiments of the invention, the used distance metric D is based on the Euclidian norm, i.e., the L2-norm. In alternative embodiments of the invention, a distance metric D can be used that is based on one of the following norms: Lp-norm with p≠2, Manhattan-Norm (L1-Norm), infinity-norm (L∞-norm), Shannon-Entropy-norm, Jensen-Shannon-Divergence-norm, Renyi-Entropy-norm, Tsallis-Entropy-norm.

The cost function is a scalar cost function, i.e., the value of the function is a real number. This is consistent with the fact that the value of the cost function is identical to the value of the mathematical distance metric D. Here, only mathematical distance metrics D are considered that produce positive real distances. This is the case for each of the above-mentioned examples of metrics.

It can be considered a first important advantage that the invention dispenses with the traditional SIM requirement that the illumination must be uniform on average. In other words, the invention corrects for non-uniformity in the illumination profile. A further important advantage of the invention is that drawbacks and limitations of presently available SIM-systems can be avoided or mitigated. These drawbacks and limitations comprise the data analysis being incapable of modeling imperfections on, e.g., the grating such as dust and scratches, optical aberrations in the illumination path such as vignetting and field curvature altering the appearance of the grating incident on the specimen, and imperfections of optical aberrations in the detection path such as vignetting and field curvature and defects of the detector, e.g., a camera, reducing the quality of the measurement data. A further advantage of the invention with respect to presently available SIM-systems is that dedicated hardware for moving a grating in the illumination beam path is not needed when the sample is mounted on a laterally movable stage which is oftentimes the case. As compared to the presently available widefield microscopy systems where sectioning is not possible it can be considered an advantage of the invention that without the need of substantial further hardware a sectioning mode becomes available. A further advantage of the invention is that components of existing systems, namely a grating of an existing SIM-system and a translation stage of an existing widefield microscopy system or the slide scanner can be used and combined. Contrary to existing SIM-methods, the microscope and the method according to the invention allow to use in principle any type of illumination modulation. It would, e.g., be possible to use variable line space gratings, where the coarse part of the grating helps, at the cost of contrast, though, imaging deeper into tissue than the less coarse part. In contrast thereto, existing SIM-systems use a fixed grating pitch that leaves no such degree of freedom. Also, contrary to existing SIM-systems where a 1-dimensional grating is used which can lead to anisotropic resolution and imaging artefacts in the SIM-processing, the present invention principally allows to use anisotropic structures.

The illumination structure as such can be used as an absolute positioning scale. It is, e.g., possible to use aperiodic tessellations such as Penrose tilings that allow for absolute position referencing of the object with respect to the illumination. As the local neighborhood, e.g., in Penrose tilings, never repeats itself, such patterns can be used as an optical ruler. This allows for improved image mosaicking in slide scanning applications, including faster and more precise stitching.

Contrary to the setup used by Neil et al. in [1] the invention is not limited to a grating or grid in a field aperture, i.e., an intermediate image plane position. In addition, instead of laterally translating the grating, the invention allows to laterally translate the sample specimen which happens anyway in whole slide scanning applications. As compared to the HiLo method it can be considered an advantage of the invention that no coherent light sources are needed and LED sources can be used. Unlike DSI and RIM which are agnostic of the illumination pattern exciting the specimen and where, for extracting a robust estimate of the specimen, hundreds of images must be acquired until the autocovariance stabilizes sufficiently and allows for extracting a robust estimate of the specimen, the present invention explicitly compensates for the variation in the excitation patterns and is thus less complex in this regard.

Contrary furthermore to DSI-systems where a coherent light source is needed for the generation of speckles the present invention can use incoherent sources. It is well known that the sectioning capability of SIM with incoherent sources is better than with coherent sources, see, e.g., the chapter on structured illumination microscopy in [6]. Finally, contrary to DSI-systems, as will be explained further below, the present invention allows in preferred variants to jointly estimate the object and illumination mean and variances.

In a preferred embodiment of the microscope according to the invention, the control unit is configured for using, in the sample information calculation step, the cost function

$$L = {[ σ ( {J}_{k} \cdot S ) - σ ( {C}_{k} ) ]}^{2} ,$$

wherein σ is the standard mean deviation with respect to the sample illumination pattern index k, and for calculating the microscopic sample information S as

$$S = σ ( {C}_{k} ) / σ ( {J}_{k} ) . \qquad ( 1 )$$

When the sample is shifted and the structured illumination is fixed, it has to be considered that because of the finite size of, e.g., a camera, each sample shift causes part of the sample information to leave the image field of view, while new parts of the sample enter on the opposite side into the field of view. Each object pixel may have been excited by a structured illumination a single time or multiple times, i.e., generally, different pixels are excited a different number of times. One can keep track of how many times each object pixel was excited using a weighting mask W(x), which is 1 where the specimen is illuminated and 0 elsewhere.

More specifically, in a further preferred embodiment, the control unit is configured for sequentially changing the sample illumination pattern Jₖ by sequentially setting the mechanical drive to specific relative lateral positions mx between the sample and the microscope objective with respect to an optical axis of the microscope objective and for calculating, in the sample information calculation step,

$$σ ( {C}_{k} ) = β \cdot {( {\sum }_{k} {W}_{k} ( x - {m}_{k} ) {( C ( x - {m}_{k} ) - {μ}_{data} ( x ) )}^{2} )}^{1 / 2} \\ and$$

$$σ ( {J}_{k} ) = β \cdot {( {\sum }_{k} {W}_{k} ( x - {m}_{k} ) {( S ( x - {m}_{k} ) - {μ}_{illu} ( x ) )}^{2} )}^{1 / 2}$$

wherein
C(x−mₖ) are the measurement data collected for the lateral position mx and thus for sample illumination pattern Jₖ
S(x−mₖ) is the contribution of the microscopic sample information obtained at the lateral position mx and thus for sample illumination pattern Jₖ
Wₖ is a weight mask that is 1 inside a window in which the sample is illuminated with the kth sample illumination pattern Jₖ and 0 elsewhere,

$${β}^{2} = 1 / ( {\sum }_{k} {{W}_{k} ( x - {m}_{k} )}^{2} + α ) \\ {μ}_{data} ( x ) = {β}^{2} \cdot {\sum }_{k} {W}_{k} ( x - {m}_{k} ) C ( x - {m}_{k} ) , {μ}_{illu} ( x ) = {β}^{2} \cdot {\sum }_{k} {W}_{k} ( x - {m}_{k} ) S ( x - {m}_{k} ) ,$$

mₖ is a lateral shift of the sample needed to expose the sample to the kth sample illumination pattern Jₖ,
ais a non-zero scalar to prevent division by zero
and using the calculated σ(Cₖ) and σ(Jₖ) for calculating S=σ(Cₖ)/σ(Jₖ).

This notation is needed since either the sample or the pattern of structured illumination light can be shifted. The weight masks Wₖ therefore keep track of averaging only those regions that were illuminated.

In a particularly preferred embodiment of the invention, the control unit is further configured for recursively calculating a mean and a variance of each of the measurement data Cₖ and the sample illumination patterns Jₖ with respect to the sample illumination pattern index k by calculating an updated mean μ_{K} and an updated variance ok of the measurement data Cₖ and the sample illumination patterns Jₖ, respectively, based on a previously calculated mean μ_{K-1} and a previously calculated variance σ_{K-1}² of the measurement data Cₖ and the sample illumination patterns Jₖ, respectively, and a most recently applied sample illumination pattern J_{K} and most recently measurement data C_{K} obtained for the most recently sample illumination pattern J_{K}.

As only the sample mean and variance are stored, i.e., not every data point, this allows to estimate a sectioned image of a specimen without keeping large data sets. This can be advantageous for high speed and large-throughput optical sectioning in whole slide scanners.

More specifically, the control unit can be further configured for calculating the updated mean μ_{K}(C) and the updated variance

$${σ}_{K}^{2} ( C )$$

of the measurement data Cₖ as:

$${μ}_{K} ( C ) = \frac{1}{K} [ ( K - 1 ) {μ}_{K - 1} ( C ) + {C}_{K} ] {σ}_{K}^{2} ( C ) = \frac{1}{K - 1} [ ( K - 2 ) {σ}_{K - 1}^{2} ( C ) + \frac{K}{K - 1} {( {μ}_{K} ( C ) - {C}_{K} )}^{2} ]$$

and for calculating the updated mean μ_{K}(J) and the updated variance

$${σ}_{K}^{2} ( J )$$

of the sample illumination patterns Jₖ as:

$${μ}_{K} ( J ) = \frac{1}{K} [ ( K - 1 ) {μ}_{K - 1} ( J ) + {I}_{K} ] \\ {σ}_{K}^{2} ( J ) = \frac{1}{K - 1} [ ( K - 2 ) {σ}_{K - 1}^{2} ( J ) + \frac{K}{K - 1} {( {μ}_{K} ( J ) - {J}_{K} )}^{2} ]$$

wherein
K is the illumination pattern index of the most recently applied sample illumination pattern J_{K}

In cases where the sample is shifted and the pattern of structured illumination light is fixed, one can, as explained above, keep track of how many times each object pixel was excited using a weighting mask. More specifically, the control unit can be further configured for calculating the updated mean μ_{K}(C) and the updated variance

$${σ}_{K}^{2} ( C )$$

of the measurement data Cₖ as:

$${μ}_{K} ( C ) = \frac{1}{{γ}_{K}} \cdot ( {γ}_{K - 1} \cdot {μ}_{K - 1} ( C ) + {W}_{K} \cdot {C}_{K} ) \\ {σ}_{K}^{2} ( C ) = \frac{1}{{γ}_{K}} \cdot ( {γ}_{K - 1} \cdot {σ}_{K - 1}^{2} ( C ) + {{W}_{K} ( {μ}_{K} ( C ) - {C}_{K} )}^{2} )$$

and the updated mean μ_{K}(J) and the updated variance σ_{K}²(J) of the illumination patterns Jₖ as:

$${μ}_{K} ( J ) = \frac{1}{{γ}_{K}} \cdot ( {γ}_{K - 1} \cdot {μ}_{K - 1} ( J ) + {W}_{K} \cdot {J}_{K} ) \\ { σ}_{K}^{2} ( J ) = \frac{1}{{γ}_{K}} \cdot ( {γ}_{K - 1} \cdot {σ}_{K - 1}^{2} ( J ) + {{W}_{K} ( {μ}_{K} ( J ) - {J}_{K} )}^{2} ) \\ wherein$$

$${γ}_{K} = {\sum }_{k = I}^{K} {W}_{k}^{2}$$

Wₖ is a weight mask that is 1 inside a window in which the sample was illuminated with the kth sample illumination pattern Jₖ and 0 elsewhere,
   and using the calculated updated variance

$${σ}_{K}^{2} ( C )$$

of the measurement data Cₖ and the calculated updated variance

$${σ}_{K}^{2} ( J )$$

of the sample illumination patterns Jₖ for calculating an updated estimate S_{K} of the microscopic sample information as

$${S}_{K} = \sqrt{{σ}_{K}^{2} ( C ) / {σ}_{K}^{2} ( J )} .$$

The control unit can further be configured for using as initial estimates

$${μ}_{0} ( J ) = {J}_{1} , {μ}_{0} ( C ) = {C}_{1} , {σ}_{0}^{2} ( J ) = 0 , and {σ}_{0}^{2} ( C ) = 0.$$

In a preferred embodiment of the method according to the invention, prior to subjecting the sample to illumination patterns, a widefield image is recorded without applying any illumination pattern using the microscopy method described in the German patent application 10 2024 124 248.5 filed recently by the same applicant. This widefield image can be used as μ₀(C)=C₁.

Mean and variance distill properties of a data, for example where the data is centered (the mean) and how much it is spread around the mean (variance). In practice both the mean and variance are not robust to outliers. The control unit can also be configured for calculating, instead of the mean of the measurement data and the sample illumination patterns, the median of the measurement data and the sample illumination patterns, respectively.

The control unit can also be configured for calculating, instead of the variance of the measurement data and the sample illumination patterns, one of the following measures of a statistical dispersion for the measurement data and the sample illumination patterns, respectively:
mean absolute deviation from the median (MAD),
a measure of a statistical dispersion based on an entropy calculated along a sample illumination pattern index, wherein the entropy is one of the Shannon-Entropy, the Jensen-Shannon-Divergence, the Renyi-Entropy, the Tsallis-Entropy,
one of the robust variance measures described in reference [11],
one of the variance measures contained in the equations 1. to 5., 6a., 6b., 7a., 7b. in the box in the left column on page 269, of reference [12].

In a further alternative, the control unit can be further configured for using adaptive weights instead of weighted variances wherein the adaptive weights contain a measure of a deviation of the measurement data from the calculated microscopic sample information. E.g., the control unit can be configured for using adaptive weights that are inversely proportional to a residual between the calculated microscopic sample information and the measurement data and zero where no measurement data are observed.

A particularly preferred variant of the microscopy method according to the invention further comprises determining at least one, preferably each, of the used patterns of structured illumination light prior to the measurement data collection step or as a part of the measurement data collection step and prior to the sample information calculation step.

It can be assumed that, in each case, the respective lateral positions of the sample with respect to the optical axis of the microscope objective and thus the spatial relationship between the sample and the respectively used patterns of structured illumination light are known. Thus, once the used patterns of structured illumination light are determined, the applied sample illumination patterns are known. In the simplest case where a fixed light modulator, e.g., a fixed mask or a fixed grating is used only one pattern of structured illumination light needs to be determined.

In a corresponding preferred embodiment of the microscope according to the invention the control unit is configured for determining at least one, in particular each, of the patterns of structured illumination light prior to the measurement data collection step or as a part of the measurement data collection step and prior to the sample information calculation step.

In the German patent application 10 2024 124 248.5 filed recently by the same applicant, a method for determining a field inhomogeneity in a field of view of a microscope and a microscope for carrying out this method have been described. In a preferred embodiment of the microscope according to the invention, the control unit is further configured for determining a pattern of structured illumination light Iᵥ as a field inhomogeneity in a field of view of the microscope according to one of the methods for determining a field inhomogeneity in a field of view of a microscope described in the German patent application 10 2024 124 248.5.

More specifically, for determining a pattern of structured illumination light Iᵥ, the control unit can be configured for carrying out the following steps:
a) a setting step wherein the mechanical drive is sequentially set to at least three different relative lateral positions while the sample or a second sample is illuminated with the respective pattern of structured illumination light Iᵥ,
b) a collecting step, in particular as a part of the measurement data collection step, wherein, in the different relative lateral positions measurement data are collected from the detector at least for a subset of points in the sample or the second sample in a field of view of the detection beam path, wherein for each of the points in the subset measurement data are collected for at least two different lateral positions of the mechanical drive while the sample or a second sample is illuminated with the pattern of structured illumination light Iᵥ,
c) an evaluation step wherein, based upon the measurement data collected in the collecting step, the following steps are carried out:
   c1) extracting from the measurement data the pattern of structured illumination light Iᵥ in the field of view used in steps a) and b) and using the assumption that the pattern of structured illumination light Iᵥ is not dependent of the respectively set relative lateral position and
   c2) extracting from the measurement data a sample information representing a portion of the measurement data caused by the sample used in steps a) and b).

A corresponding preferred variant of the microscopy method according to the invention determining a pattern of structured illumination light Iᵥ comprises the following steps:
A) a setting step wherein specific relative lateral positions between the sample or a second sample and the microscope objective are set with respect to an optical axis of the microscope objective by means of a mechanical drive wherein the mechanical drive is sequentially set to at least three different relative lateral positions while the sample or the second sample is illuminated with the respective pattern of structured illumination light Iᵥ,
B) a collecting step, in particular as a part of the measurement data collection step, wherein, in the different relative lateral positions, measurement data are collected from the detector at least for a subset of points in the sample or the second sample in a field of view of the detection beam path, wherein for each of the points in the subset measurement data are collected for at least two different lateral positions of the mechanical drive while the sample or the second sample is illuminated with the respective pattern of structured illumination light Iᵥ,
C) an evaluation step wherein, based upon the measurement data collected in the collecting step, the following steps are carried out:
   C1) extracting from the measurement data the respective pattern of structured illumination light Iᵥ in the field of view used in steps A) and B) and using the assumption that the pattern of structured illumination light Iᵥ is not dependent of the respectively set relative lateral position and
   C2) extracting from the measurement data a sample information representing a portion of the measurement data caused by the sample used in steps A) and B).

Generally, it is possible to use the same sample for the determination of the patterns of structured illumination light Iᵥ that is also investigated with the microscope and the method according to the invention. This can be considered a further advantage of the present invention. But it is also possible to use a second sample, e.g., a thin two-dimensional sample, for a prior determination of the pattern or patterns of structured illumination light Iᵥ.

Generally, at least three relative lateral positions need to be set in the setting step and for each of the points in the subset of points, measurement data are recorded for at least two different relative lateral positions. In a preferred embodiment of the invention, the set relative lateral positions are located on a two-dimensional regular grid. The grid can, e.g., be rectangular or triangular.

The requirement that for each of the points in the subset of points, measurement data are recorded for at least two different relative lateral positions can preferably achieved when the control unit is further configured in such a way that in the two-dimensional grid of set relative lateral positions in the setting step an overlap between neighboring tiles is at least 50% in a first coordinate direction. In a further preferred embodiment of the invention, the control unit is further configured in such a way that in the two-dimensional grid of set relative lateral positions in the setting step an overlap between neighboring tiles is at least 5% and preferably at least 10% in a second coordinate direction which can be in particular perpendicular to the first coordinate direction.

In a further preferred embodiment the points in the subset of points are evenly distributed over the field of view. E.g., the points in the subset of points can be located on a regular grid. The grid of the subset of points can be rectangular or triangular. In a situation where the field inhomogeneity, i.e., presently the respective pattern of structured illumination light Iᵥ, is to be determined to a high level of accuracy, the collecting step preferably comprises collecting measurement data for each of the points in the field of view. In a situation where the field inhomogeneity, i.e., presently the respective pattern of structured illumination light Iᵥ, is to be determined quickly, the evaluation step can comprise a binning of measurement data of a plurality of points, in particular a plurality of pixels.

In a situation where the field inhomogeneity, i.e., presently the respective pattern of structured illumination light Iᵥ, is to be determined quickly and/or to only a moderate level of accuracy, it would be sufficient to evaluate only the measurement data for a subset of points. If the field inhomogeneity, presently the respective pattern of structured illumination light Iᵥ, is to be determined to a high level of accuracy, though, the evaluation step preferably comprises evaluating the measurement data of each of the points in the field of view.

The control unit can be configured for carrying out the evaluation step as an iterative solution of a double-blind estimation problem based upon an initial estimate of the pattern of structured illumination light Iᵥ and an initial estimate of the microscopic sample information.

More specifically, the control unit can be configured for carrying out at least some or all of the following steps in the evaluation step:
calculating an estimate of the microscopic sample information based on the measurement data and using an initial estimate of the pattern of structured illumination light Iᵥ,
iteratively calculating
   updated estimates of the pattern of structured illumination light Iᵥ based on the measurement data and using in each case a most recent estimate of the microscopic sample information and
   updated estimates of the microscopic sample information based on the measurement data and using in each case a most recent estimate of the pattern of structured illumination light Iᵥ,
evaluating an accuracy level to which the most recent estimate of the pattern of structured illumination light Iᵥ and the most recent estimate of the microscopic sample information reproduce the measurement data,
repeating the step of iteratively calculating updated estimates of the pattern of structured illumination light Iᵥ and updated estimates of the microscopic sample information until the measurement data are reproduced by the most recent estimate of the pattern of structured illumination light Iᵥ and the most recent estimate of the microscopic sample information to a specified level of accuracy.

Additionally or alternatively, the control unit can be further configured to carry out at least some or all of the following steps in the evaluation step:
calculating an initial estimate of the microscopic sample information based on the measurement data and using an initial estimate of the pattern of structured illumination light Iᵥ;
calculating a first updated estimate of the pattern of structured illumination light Iᵥ based on the measurement data and using the initial estimate of the microscopic sample information;
calculating a first updated estimate of the microscopic sample information based on the measurement data and using the first updated estimate of the pattern of structured illumination light Iᵥ;
calculating an (n+1)th updated estimate of the pattern of structured illumination light Iᵥ based on the measurement data and using the nth updated estimate of the microscopic sample information; and
calculating an (n+1)th updated estimate of the microscopic sample information based on the measurement data and using the (n+1)th updated estimate of the pattern of structured illumination light Iᵥ.

An initial estimate of the pattern of structured illumination light Iᵥ can, e.g., be a flat illumination profile.

In a further embodiment, the control unit can additionally or alternatively be further configured to carry out the evaluation step as a minimization of a mathematical distance between the measurement data and a combination of the pattern of structured illumination light Iᵥ and the microscopic sample information, wherein the mathematical distance is based on an arbitrary mathematical norm.

In a further embodiment, the control unit can additionally or alternatively be further configured to carry out the following steps in the evaluation step: taking a new estimate of the pattern of structured illumination light Iᵥ as a new updated estimate of the pattern of structured illumination light/, and a new estimate of the microscopic sample information as a new updated estimate of the microscopic sample information
if the value of a first scalar cost function for the new estimate of the pattern of structured illumination light Iᵥ and the new estimate of the microscopic sample information is smaller than the value of the first scalar cost function for the most recent updated estimate of the pattern of structured illumination light Iᵥ and the most recent updated estimate of the microscopic sample information and
if the value of a second scalar cost function for the new estimate of the pattern of structured illumination light Iᵥ and the new estimate of the microscopic sample information is smaller than the value of the second scalar cost function for the most recent updated estimate of the pattern of structured illumination light Iᵥ and the most recent updated estimate of the microscopic sample information,
wherein the first scalar cost function and the second scalar cost function in each case contain a mathematical distance between the measurement data and a combination of the pattern of structured illumination light Iᵥ with the microscopic sample information and
wherein the first scalar cost function L₁ contains the norm of the pattern of structured illumination light Iᵥ and the second scalar cost function L2 contains the mathematical norm of the microscopic sample information.

The combination of the pattern of structured illumination light Iᵥ with the microscopic sample information can be, e.g., a product of the pattern of structured illumination light Iᵥ and the microscopic sample information.

The mathematical norms can be one of the following norms: Lp-norm L2-norm (Euclidian norm), Manhattan-Norm (L1-Norm), infinity-norm (L∞-norm, Shannon-Entropy-norm, Jensen-Shannon-Divergence-norm, Renyi-Entropy-norm, Tsallis-Entropy-norm.

In a particularly preferred embodiment, the first cost function L1 and the second cost function L2 are respectively given by

$${L}_{1} = \frac{1}{2} {\sum }_{x} {\sum }_{m} {[ ( {I}_{v} ( x ) {S}_{v} ( x - m ) - C ( x \vert m , v ) ]}^{p} + \frac{{μ}_{1}}{2} {{I}_{v} ( x )}^{p} \\ {L}_{2} = \frac{1}{2} {\sum }_{x} {\sum }_{m} {[ ( {I}_{v} ( x + m ) {S}_{v} ( x ) - C ( x + m \vert m , v ) ]}^{p} + \frac{{μ}_{2}}{2} {{S}_{v} ( x )}^{p}$$

wherein
C(x|m, v) are the measurement data for the vth pattern of structured illumination light Iᵥ at the lateral position m of the sample with respect to the microscope objective
Iᵥ(x) is the pattern of structured illumination light Iᵥ
Sᵥ(x) is the microscopic sample information
μ₁ and μ₂ are non-zero scalars
m is a two-dimensional vector in the x₁, x₂-plane
x is a two-dimensional vector in the x₁, x₂-plane
p is a positive integer

In a preferred embodiment, p=2, i.e., the used norm is the Euclidian norm. This minimization algorithm thus minimizes the quadratic distances between the combination of the field inhomogeneity, i.e., presently the pattern of structured illumination light Iᵥ, with the microscopic sample information, e.g., the product of the field inhomogeneity with the microscopic sample information, and the measurement data. For this embodiment, the (n+1)th updated estimate of the pattern of structured illumination light Iᵥ is calculated as follows:

$${I}_{v , n + 1} ( x ) = \frac{{Σ}_{m} {S}_{v , n} ( x - m ) C ( x \vert m , v )}{{Σ}_{m} {{S}_{v , n} ( x - m )}^{2} + {μ}_{1}}$$

and the (n+1)th updated estimate of the microscopic sample information is calculated as follows:

$${S}_{v , n + 1} ( x ) = \frac{{Σ}_{m} {I}_{v , n} ( x + m ) C ( x + m \vert m , v )}{{Σ}_{m} {{I}_{v , n} ( x + m )}^{2} + {μ}_{2}}$$

wherein
C(x|m, v) are the measurement data for the vth pattern of structured illumination light Iᵥ at the lateral position m of the sample with respect to the microscope objective, can shortly also be written Cᵥ(m)
I_{v,n+1}(x) is (n+1)th updated estimate of the pattern of structured illumination light Iᵥ
I_{v,n}(x) is the nth updated estimate of the estimate of the pattern of structured illumination light Iᵥ
S_{v,n}(x) is the nth updated estimate of microscopic sample information Sᵥ(x)
S_{v,n+1}(x) is the (n+1)th updated estimate of microscopic sample information Sᵥ(x) μ₁ and μ₂ are non-zero scalars
m is a two-dimensional vector in x₁, x₂-plane
x is a two-dimensional vector in the x₁, x₂-plane
p is a positive integer

For p=2 this variant of the method for determining a field inhomogeneity, i.e., presently the respective illumination pattern Iᵥ, in a field of view of the microscope according to the invention and/or the underlying algorithm can be termed an alternating least squares shading correction algorithm or ALS-SC algorithm. It is noted that the ALS-SC algorithm's iterative update steps are linear in the observed data Cᵥ(m) contrary to classical SIM.

The equations above used to estimate S_{v,n+1}(x) and I_{v,n+1}(x) do not confer optical sectioning capability to a wide field microscope. For example, Sᵥ(x) as estimated from the above equations yields a standard wide field micrograph of the sample including out-of-focus signal when illuminated with the pattern of structured illumination light Iᵥ.

For setting a specified axial distance between the sample and the microscope objective, the microscope can further comprise an axial drive. The control unit is configured for controlling the axial drive.

Additionally or alternatively, at least one of the detection beam path and the illumination beam path can comprise at least one variable optical component for changing an axial position of an observed plane in the sample. The control unit can be configured for controlling the at least one variable optical component. The variable optical component can comprise at least one of a tunable optical lens, a spatial light modulator, a variable lens group, a zoom optics.

The microscope according to the invention can be at least one of a wide-field microscope, a scanning microscope, a light-field microscope, a light-sheet-microscope, a TIRF-microscope, a SIM-microscope.

Further properties and advantages of the invention will be described in the following in relation to the attached drawings. In the drawings,

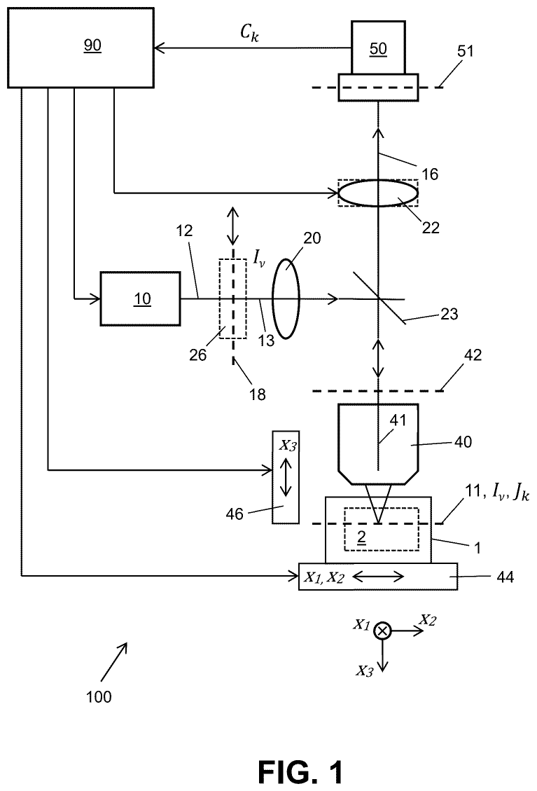

FIG. 1 shows a schematic depiction of a microscope according to the invention;

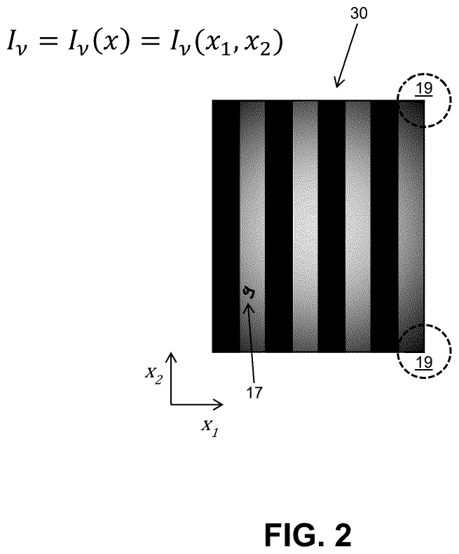

FIG. 2 shows a schematic depiction of a first example of a pattern of structured illumination light;

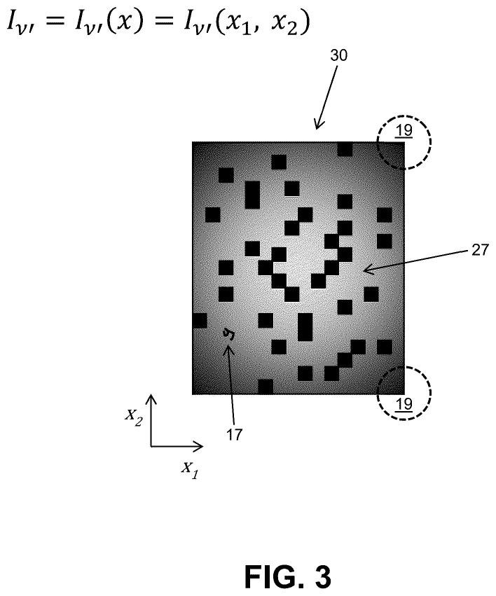

FIG. 3 shows a schematic depiction of a second example of a pattern of structured illumination light;

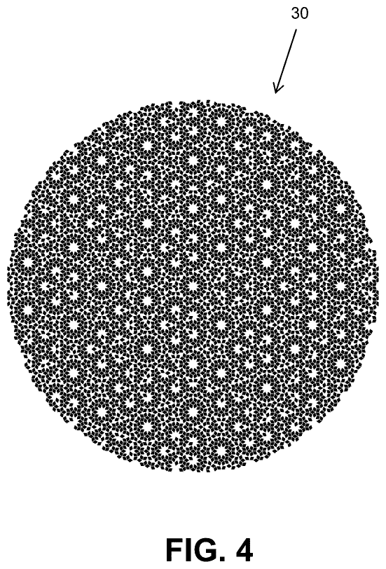

FIG. 4 shows a schematic depiction of a third example of a pattern of structured illumination light;

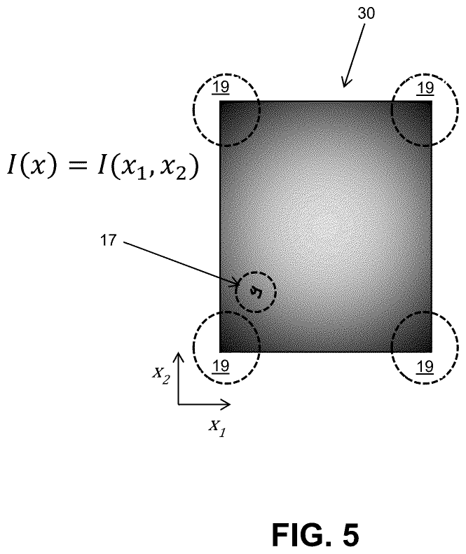

FIG. 5 shows a schematic representation of a field inhomogeneity of a detection beam path of a microscope;

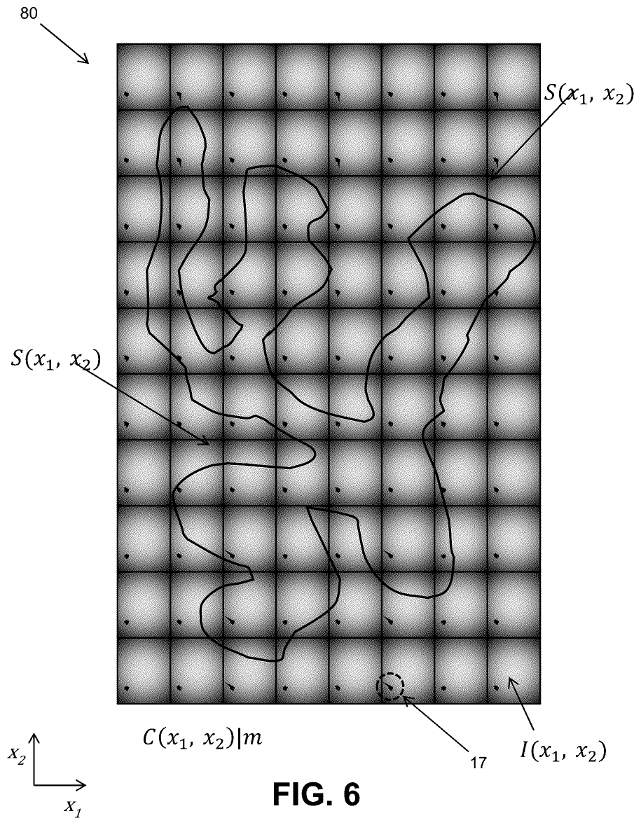

FIG. 6 shows a schematic representation of a stitched image of measurement data consisting of a plurality of image tiles and showing in each case the field inhomogeneity and in some cases portions resulting from a sample;

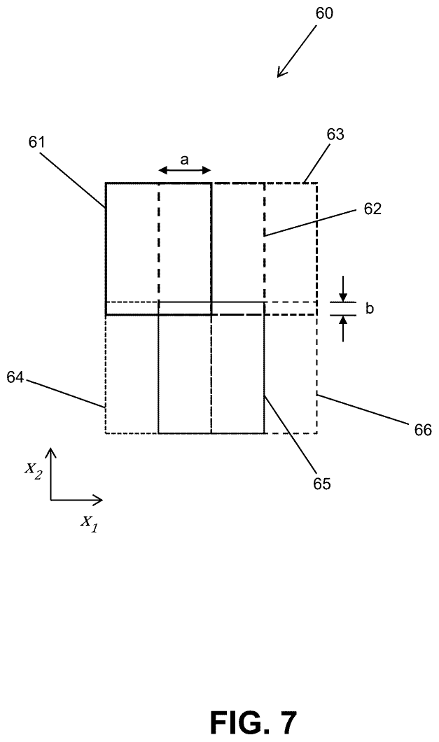

FIG. 7 shows a schematic representation of six overlapping image tiles;

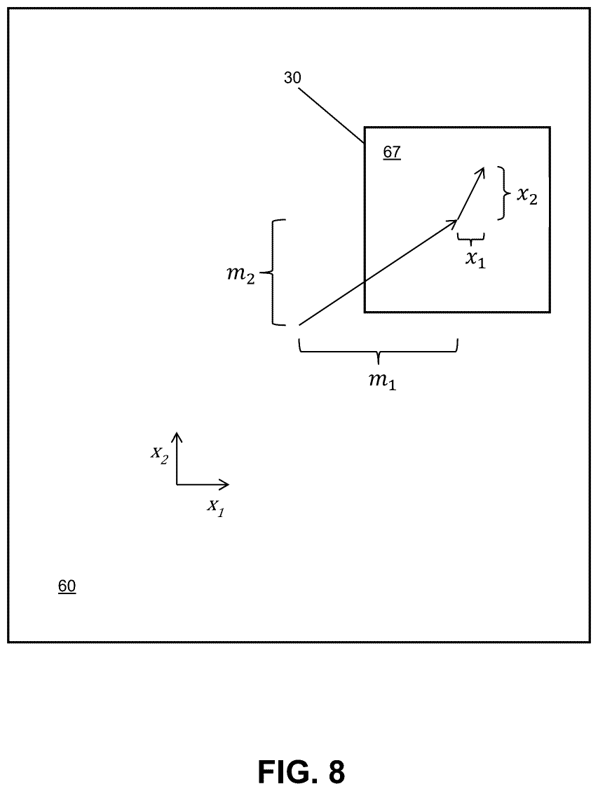

FIG. 8 shows a schematic representation of used coordinates;

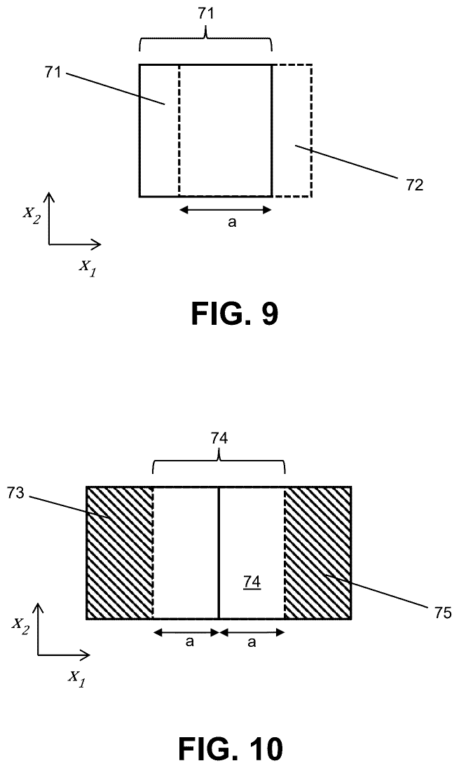

FIG. 9 shows a schematic representation of two overlapping image tiles;

FIG. 10 shows a schematic representation of three overlapping image tiles; and

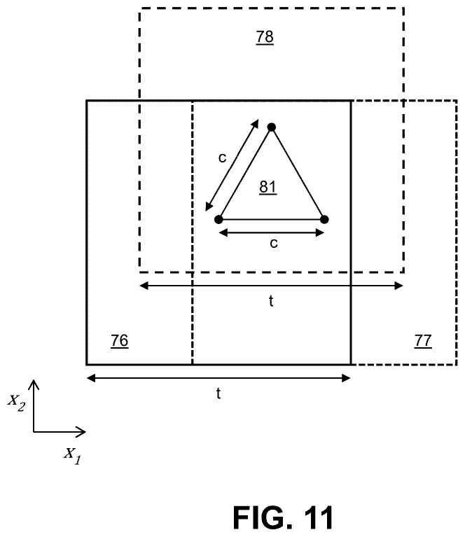

FIG. 11 shows a further schematic representation of three overlapping image tiles.

An embodiment of a microscope 100 according to the invention will be described with reference to FIGS. 1 to 10. Identical and equivalent components are generally denoted with the same reference numbers. The microscope 100 can be configured for carrying out at least one of or all of the variants of the microscopy method according to the invention described herein.

First, the microscope 100 comprises a light source 10 for supplying illumination light 12 and an illumination beam path for guiding the illumination light 12 to a sample space 1. According to the invention, the illumination beam path comprises a light manipulation device 26 for generating structured illumination light 13 and, more specifically, at least one pattern of structured illumination light Iᵥ. In the shown example, the light manipulation device 26 is realized by or comprises a transmission grating 26. The grating 26 can be moved at least laterally, i.e., in a direction perpendicular to the optical axis, namely the direction of the illumination light 12. A movement of the grating 26 at least in the lateral direction and optionally also in the axial direction can be brought about by actors not shown in FIG. 1 and which can be controlled by a control unit 90, e.g., a PC. The lateral degree of freedom of the transmission grating 26 is indicated in FIG. 1 by the double-headed arrow above the grating 26. The control unit 90 of the microscope 100 can in particular be configured for carrying out the method according to the invention. The methods according to the invention can comprise using the microscope 100.

In the shown example, the illumination beam path comprises further a tube lens 20, a main beam splitter 23, and a microscope objective 40. The tube lens 20 creates an intermediate image plane 18, i.e., a plane which is optically conjugate to a plane 11 in a sample 2 in the sample space 1. In the shown example, the light manipulation device 26 is arranged in or in the vicinity of this intermediate image plane 18. Downstream of the light manipulation device 26, i.e., the grating 26, the illumination light 12 travels as structured illumination light 13 via the tube lens 20 to the main beam splitter 23 and is reflected there in the direction of the microscope objective 40. The structured illumination light 13 then passes through a back focal plane 42 of the microscope objective 40 and is subsequently guided into the plane 11 in the sample 2. In its spatial relation with respect to the sample 2, the pattern of structured illumination light Iᵥ created by the grating 26 realizes a sample illumination pattern Jₖ, where k is a sample illumination pattern index being an integer or zero.

The sample 2 can be a biological sample and can be prepared with fluorophores which can be excited by the illumination light 12. A wavelength and an intensity of the illumination light 12 can be suitably chosen with regard to the sample 2 and the used fluorophores. The light source 10 may comprise a plurality of different LEDs or different lasers. The wavelength and/or the intensity of the illumination light 12 can be adjustable.

Furthermore, the microscope 100 comprises a detector 50 for detecting emission light 16 emitted by the sample 2 in the sample space 1 and a detection beam path comprising a microscope objective 40 for guiding the emission light 16 to the detector 50. In the shown example, the microscope 100 is a widefield microscope and the detector 50 is a camera, i.e., a field of view 30 (see FIG. 5) of the detection beam path is imaged on a sensor plane 51 of the camera 50. Expediently, the sensor plane 51 is optically conjugate to the plane 11 in the sample space 1.

The emission light 16 emitted by the sample 2 upon irradiation with the structured illumination light 13 can typically be red-shifted fluorescent light emitted by the fluorophores in the sample 2. The main beam splitter 23 is configured for transmitting the red-shifted emission light 16 and for reflecting the illumination light 12 thus avoiding that large portions of illumination light 12 scattered back from the sample space 1 travel in the direction of the camera 50.

In the detection beam path, the emission light 16 emitted by the sample 2 is collected by the microscope objective 40, passes through the main beam splitter 23 and is then imaged by an adjustable tube lens 22 into the sensor plane 51 of the camera 50. The adjustable tube lens 22 is controllable by the control unit 90 and serves the purpose of adjusting a location of the plane 11 imaged on the sensor plane 51 of the camera 50 in the direction of an optical axis 41 of the microscope objective 40, i.e., in the x₃-direction. According to the invention, the control unit 90 is configured for collecting and evaluating measurement data Cₖ from the detector, i.e., the camera 50. Cₖ denote measurement data collected from the sample 2 while it is being subjected to the kth sample illumination pattern Jₖ·

As generally known in the art, an excitation filter can be present in the excitation beam path, e.g., between the tube lens 20 and the main beam splitter 23, and/or an emission filter can be present in the detection beam path, e.g., between the adjustable tube lens 22 and the main beam splitter 23. It is also possible to have a plurality of different main beam splitters 23 adapted to individual fluorophores which can be switched into the beam path.

Moreover, in the shown embodiment, the microscope 100 comprises a mechanical drive 44 for setting a relative lateral position x₁, x₂ between the sample 2 and the microscope objective 40 with respect to the optical axis 41 of the microscope objective 40. In the shown embodiment, the control unit 90 is further configured for controlling the mechanical drive 44.

In the shown example, the optical axis 41 of the microscope objective 40 extends in the direction of the x₃-axis. The mechanical drive 44 can, e.g., be part of a motorized sample stage and, in the shown example, serves the purpose of setting a specified position of the sample 2, i.e., specified x₁, x₂-coordinates of the sample 2 with respect to the optical axis 41. A right-handed orthogonal coordinate system x₁, x₂, x₃ is shown below the mechanical drive 44. In the shown example, the microscope 100 further comprises an axial drive 46 serving the purpose of setting a specified axial distance, i.e., a distance in the x₃-direction between the sample and the microscope objective 40.

Different sample illumination patterns Jₖ carry an in each case sample different illumination pattern index k. The sample illumination pattern Jₖ can be changed by changing the pattern of structured illumination light Iᵥ as such and/or by changing the spatial relation of the sample 2 with respect to the pattern of structured illumination light Iᵥ. In the shown example, the pattern of structured illumination light Iᵥ and, thus, the sample illumination pattern Jₖ, can be changed by shifting the grating 26 to a different lateral position in the illumination beam path. The spatial relation between the sample 2 and the pattern of structured illumination light Iᵥ and, thus, the sample illumination pattern Jₖ, can be changed by changing a relative lateral position between the sample 2 and the microscope objective 40 with respect to an optical axis 41 of the microscope objective 40. I.e., the same pattern of structured illumination light Iᵥ can be used to produce different sample illumination patterns Jₖ. This option is in many cases preferred for experimental simplicity. Changing both, the pattern of structured illumination light Iᵥ and the lateral position between the sample 2 and the microscope objective 40 with respect to an optical axis 41 of the microscope objective 40, leaves the theoretical possibility that the manipulations cancel each other out and that the illumination pattern Jₖ remains in fact unchanged.

According to the invention, the control unit 90 is configured for carrying out the following steps:
a measurement data collection step wherein measurement data Cₖ are collected from the detector, i.e., the camera 50, while the sample 2 is sequentially illuminated with at least two different sample illumination patterns Jₖ and
a sample information calculation step wherein a microscopic sample information S is calculated which minimizes or maximizes the scalar cost function

$$L = D [ ρ ( {J}_{k} \cdot S ) , ρ ( {C}_{k} ) ] ,$$

wherein ρ is a measure of statistical dispersion with respect to the sample illumination pattern index k, and D is a distance metric.

The measure of statistical dispersion p can preferably be the standard mean deviation σ. Instead of the standard mean deviation σ many other measures of statistical dispersion ρ can be used as described above, most notably the mean of the absolute deviation from the mean MAD. The used distance metric D is preferably based on the L2-norm, i.e., the Euclidian norm. Instead of the Euclidian norm, the distance metric D can be based on many other norms as described above, most notably Entropy-based norms.

Where the standard mean deviation σ is used as the measure of statistical dispersion the used distance metric D is based on the L2-norm, the cost function L can be written as: L=[σ(Jₖ·S)−σ(Cₖ)]². Differentiating L with respect to S yields the microscopic sample information S as S=σ(Cₖ)/σ(Jₖ).

In a preferred variant, the control unit 90 is configured for sequentially changing the illumination pattern Jₖ by sequentially setting the mechanical drive 44 to specific relative lateral positions mₖ between the sample 2 and the microscope objective 40 with respect to the optical axis 41 of the microscope objective 40. S can then be calculated, in the sample information calculation step, as follows. First, the standard mean deviations of the Cₖ's and the Jₖ's are calculated as:

$$σ ( {C}_{k} ) = β \cdot {( {\sum }_{k} {W}_{k} ( x - {m}_{k} ) {( C ( x - {m}_{k} ) - {μ}_{data} ( x ) )}^{2} )}^{1 / 2} \\ and \\ σ ( {J}_{k} ) = β \cdot {( {\sum }_{k} {W}_{k} ( x - {m}_{k} ) {( S ( x - {m}_{k} ) - {μ}_{illu} ( x ) )}^{2} )}^{1 / 2}$$

wherein
Wₖ is a weight mask that is 1 inside a window in which the sample 2 is illuminated with the kth illumination pattern Jₖ and 0 elsewhere,

$${β}^{2} = 1 / ( {\sum }_{k} {{W}_{k} ( x - {m}_{k} )}^{2} + α ) \\ {μ}_{data} ( x ) = {β}^{2} \cdot {\sum }_{k} {W}_{k} ( x - {m}_{k} ) C ( x - {m}_{k} ) \\ {μ}_{illu} ( x ) = {β}^{2} \cdot {Σ}_{k} ( x - {m}_{k} ) S ( x - {m}_{k} ) ,$$

mₖ is the respective lateral shift of the sample 2 needed to expose the sample 2 to the kth illumination pattern Jₖ
α is a non-zero scalar.

Then, the calculated σ(Cₖ) and σ(Jₖ) can be used for calculating S=σ(Cₖ)/σ(Jₖ).

In another variant which can be advantageous, e.g., for high speed and large-throughput optical sectioning in whole slide scanners, means and variances of each of the measurement data Cₖ and the illumination patterns Jₖ can be recursively calculated. More specifically, the control unit 90 can be further configured for calculating an updated mean μ_{K}(C) and an updated variance

$${σ}_{K}^{2} ( C )$$

of the measurement data Cₖ as:

$${μ}_{K} ( C ) = \frac{1}{{γ}_{K}} \cdot ( {γ}_{K - 1} \cdot {μ}_{K - 1} ( C ) + {W}_{K} \cdot {C}_{K} ) \\ {σ}_{K}^{2} ( C ) = \frac{1}{{γ}_{K}} \cdot ( {γ}_{K - 1} \cdot {σ}_{K - 1}^{2} ( C ) + {{W}_{K} ( {μ}_{K} ( C ) - {C}_{K} )}^{2} )$$

and an updated mean μ_{K}(J) and an updated variance

$${σ}_{K}^{2} ( J )$$

of the illumination patterns Jₖ as:

$${μ}_{K} ( J ) = \frac{1}{{γ}_{K}} \cdot ( {γ}_{K - 1} \cdot {μ}_{K - 1} ( J ) + {W}_{K} \cdot {J}_{K} ) \\ {σ}_{K}^{2} ( J ) = \frac{1}{{γ}_{K}} \cdot ( {γ}_{K - 1} \cdot {σ}_{K - 1}^{2} ( J ) + {{W}_{K} ( {μ}_{K} ( J ) - {K}_{K} )}^{2} ) \\ wherein {γ}_{K} = {\sum }_{k = 1}^{K} {W}_{k}^{2}$$

and Wₖ is again a weight mask that is 1 inside a window in which the sample 2 was illuminated with the kth illumination pattern Jₖ and 0 elsewhere.

The calculated updated variance

$${σ}_{K}^{2} ( C )$$

of the measurement data Cₖ and the calculated updated variance

$${σ}_{K}^{2} ( J )$$

of the illumination patterns Jₖ can then be used for calculating an updated estimate S_{K} of the microscopic sample information as

$${S}_{K} = \sqrt{{σ}_{K}^{2} ( C ) / {σ}_{K}^{2} ( J )} .$$

$${μ}_{0} ( J ) = {J}_{1} , {μ}_{0} ( C ) = {C}_{1} , {σ}_{0}^{2} ( J ) = 0 , and {σ}_{0}^{2} ( C ) = 0$$

can be used respectively as initial estimates.

It has been described in detail above how the microscopic sample information S that minimizes or maximizes the cost function L=D[ρ(Jₖ·S),ρ(Cₖ)] can be calculated for the case where D is the Euclidian distance metric and ρ is the standard deviation σ. For the case of a general distance metric D and a general measure ρ of statistical dispersion with respect to the sample illumination pattern index k. The computational technique of Automatic Differentiation (AD) an numerical packages of, e.g., PyTorch and JAX can be employed. Automatic Differentiation (AD) is a computational technique that efficiently and accurately calculates derivatives of functions, which is essential in optimization problems where one seeks to minimize or maximize a scalar cost function. PyTorch, a machine learning library with a strong focus on deep learning, provides tools for building neural networks with an autograd system that records operations to automatically calculate gradients. JAX, on the other hand, extends this concept by offering just-in-time compilation to GPU/TPU through XLA, enabling high-performance computing for large-scale machine learning applications. It also supports automatic differentiation, making it suitable for tasks that require efficient and accurate gradient evaluation. Together, these tools form a powerful trio for tackling optimization problems in machine learning, where the goal is to find functions that minimize or maximize a given cost function under certain constraints.

In the variants for retrieving the microscopic sample information S described so far it is assumed that the illumination patterns Jₖ as such are known.

As will be described in the following with respect to the FIGS. 5 to 11, the microscope according to the invention can be used to determine the illumination patterns Jₖ prior to the measurement data collection step or as a part of the measurement data collection step and prior to the sample information calculation step. It can be assumed that, in each case, the respective lateral positions of the sample with respect to the optical axis 41 of the microscope objective 40 and thus the spatial relationship between the sample and the respectively used patterns of structured illumination light Iᵥ are known. Therefore, it is only necessary to determine or calibrate the used patterns of structured illumination light Iᵥ. In the simplest case where the grating 26 is kept at a fixed position only one pattern of structured illumination light Iᵥ needs to be determined.

More specifically, the control unit 90 can be configured for determining a pattern of structured illumination light Iᵥ as a field inhomogeneity in a field of view of the microscope according to one of the methods for determining a field inhomogeneity in a field of view of a microscope described in the German patent application 10 2024 124 248.5.

For determining a pattern of structured illumination light Iᵥ, the control unit 90 can be configured for carrying out a setting step (step a) wherein the mechanical drive 44 is sequentially set to at least three different relative lateral positions m while the sample 2 or a second sample is illuminated with the respective illumination pattern lₖ. There, m denotes a two-dimensional vector (m₁, m₂) in the x₁, x₂-plane. To each specific relative lateral location position m corresponds a different section or tile of the sample 2.

Measurement data collected by the camera 50 are denoted with C(x|m, v) wherein x is a two-dimensional vector denoting detector coordinates in a suitable frame of reference. E.g., the origin is in the center of a camera chip. FIG. 8 shows an exemplary vector (m₁, m₂) in the x₁, x₂-plane for a tile 67 corresponding to field of view 30 located in a specific relative lateral location position within an image 60 as defined by (m₁, m₂) as well the respective coordinates x₁, x₂ within the tile 67.

The control unit 90 can be configured further for carrying out a collecting step (step b), which can be in particular a part of the measurement data collection step, wherein, in each of the different relative lateral positions m, measurement data C(x|m, v)=C(x₁, x₂|m, v) are collected from the detector 50 at least for a subset of points in the sample 2 in the field of view 30 of the detection beam path. For each of the points of the subset measurement data C(x|m, v) are collected for at least two different lateral positions m of the mechanical drive 44 while the sample 2 or a second sample is illuminated with the pattern of structured illumination light Iᵥ. The latter feature can, e.g., be realized in an embodiment where the set relative lateral positions m are located on a two-dimensional regular grid configured in such a way that an overlap between neighboring tiles is at least 50% in a first coordinate direction x₁.

This is schematically depicted in FIGS. 9 and 10. FIG. 9 shows a first tile 71 and a second tile 72 of the same size which overlaps with the first tile 71 in the first coordinate direction x₁. The overlap a amounts to more than 50% of the width of the tiles 71 and 72 in the first coordinate direction x₁. FIG. 10 shows tiles 73, 74, and 75 having, in each case, the same size. There, exactly half of tile 73 overlaps with tile 74 and the other half of tile 74 overlaps with tile 75, i.e., the overlap a is, in each case, exactly 50% in the first coordinate direction x₁. The two-dimensional grid of set relative lateral positions m can be configured in such a way that an overlap b between neighboring tiles is at least 5% and preferably at least 10% in a second coordinate direction x₂ which is in particular perpendicular to the first coordinate direction x₁. This schematically depicted in FIG. 7. FIG. 7 shows six identical tiles 61, . . . , 66 which overlap, in each case, by an amount of 50% (arrow a), with the respective neighbors in the first coordinate direction x₁ and by an amount of 10% (arrows b) with the respective neighbors in the second coordinate direction x₂. The points in the subset of points can be evenly distributed over the field of view, e.g., on a rectangular grid.

FIG. 5 depicts schematically the field of view 30 as seen by the camera 50 without any contributions from a sample and for the purpose of illustration at this stage without any structuring of the illumination light 12, i.e., without a pattern of structured illumination light Iᵥ. This can be thought of as the image of an entirely homogeneous sample being illuminated through the illumination beam path of microscope 100 of FIG. 1 with the grating 26 being removed from the beam path. The image shows a field inhomogeneity I(x)=I(x₁, x₂) which in the shown example consists essentially of vignetting 19, i.e., a reduced intensity or shading, in the corner regions. Also, a speck of dust 17 is shown which can be, e.g., in the plane 51 of the camera 50. While the vignetting has a smooth progression, the speck of dust 17 has a comparatively sharp contour. By definition, the field inhomogeneity I(x) comprises the profile of the detected radiation without any contribution from the sample 2. The vignetting 19 in the corners is caused by the optical properties of the light source 10, the illumination beam path, the detection beam path and the camera 50. The speck of dust 17, in the shown example, is located in the camera 50. Therefore, the structure of the field inhomogeneity I(x) is not dependent on the specifically set relative lateral position m and, as such, shows in each of the recorded tiles.

This will be explained further with respect to FIG. 6. FIG. 6 schematically shows a stitched image 80 consisting of 80 individual tiles depicting in each case the respectively captured measurement data C(x|m)=C(x₁, x₂|m) from the detector 50. The set relative lateral positions m are located on a two-dimensional regular grid, namely on a rectangular grid. As can be seen, each and every one of the tiles shows the same field inhomogeneity I(x). Additionally, at least some of the tiles show contributions S(x)=S(x₁, x₂) of a sample. It has to be noted that FIG. 6 serves only the purpose of illustrating the fact that the field inhomogeneity I(x) is present in each of the tiles. FIG. 6 does not show overlapping tiles. As such, the image 80 can be thought of as showing, e.g., only half of the tiles that were measured in total.

In reality an image can consist of several hundreds of image tiles fused together into a whole slide image of a sample. Notably, the image in FIG. 6 exhibits shading artefacts across each tile, resulting in a checkerboard-like artefact in the fused whole slide image.

In reality, for the present invention, the field inhomogeneity I(x) as depicted in FIG. 5 is superposed by a pattern of structured illumination light Iᵥ. A pattern of structured illumination light Iᵥ comprises in reality the superposition of the field inhomogeneity I(x) and the respective pattern of structured illumination light Iᵥ. It is important that for the procedure for determining the pattern of structured illumination light Iᵥ described here to work, the pattern of structured illumination light Iᵥ must not be changed.

A first example of a pattern of structured illumination light Iᵥ is shown in FIG. 2. The depicted pattern of structured illumination light Iᵥ consists of a superposition of the field inhomogeneity I(x) of FIG. 5 and equally spaced vertical stripes, i.e., a periodic structure. If this pattern of structured illumination light Iᵥ is horizontally shifted by an amount of the width of the stripes the illumination of the sample 2 averaged over these two different sample illumination patterns Jₖ would be homogeneous save for the field inhomogeneity of FIG. 5. The small deviation from of the averaged illumination from homogeneity would be detrimental in the case of classical SIM, nonetheless. It is an important advantage of the present invention that neither periodic illumination patterns nor an, averaged over the different sample illumination patterns Jₖ, homogeneous illumination is necessary. I.e., aperiodic illumination patterns are also possible. An example of such a pattern of structured illumination light Iᵥ, is depicted in FIG. 3 which comprises the same field inhomogeneity I(x) as in FIGS. 2 and 5 but, instead of the vertical strip pattern a two-dimensional bar code 27. Averaged over different illumination patterns Jₖ using this pattern or similar patterns of structured illumination light Iᵥ, the illumination need not be homogeneous. E.g., the sum of a plurality of laterally shifted patterns of the sort shown in FIG. 3 need not yield a homogeneous illumination.

Instead of the two-dimensional bar code 27 the pattern of structured illumination light could also comprise aperiodic tessellations such as Penrose tilings as shown in FIG. 4. As the local neighborhood in a Penrose tiling lacks translational symmetry the Penrose tiling can be used as a two-dimensional optical ruler. Thus, such illumination patterns would allow for absolute position referencing of the object 2 with respect to the pattern of structured illumination light. It is conceived that this allows for improved image mosaicking in slide scanning applications, including faster and more precise stitching.

Returning now to the determination of the pattern of structured illumination light Iᵥ, the control unit 90 can be further configured for carrying out an evaluation step wherein, based upon the measurement data C(x|m, v) collected in the collecting step, the following steps are carried out:
c1) extracting from the measurement data C(x|m, v) the pattern of structured illumination light Iᵥ in the field of view 30 used in the setting step (step a) and the collecting step (step b) and using, as motivated above, the assumption that the pattern of structured illumination light Iᵥ is not dependent of the respectively set relative lateral position m and
c2) extracting from the measurement data C(x|m, v) a sample information Sy representing a portion of the measurement data C(x|m, v) caused by the sample used in the setting step (step a) and the collecting step (step b).

The removal of field inhomogeneity artefacts from microscopy data can be considered an inverse problem. Ignoring multiple scattering of light inside thick specimens, it is possible to model the measurement data, e.g., a camera signal C(x|m, v), as a product of an illumination profile, i.e., the field inhomogeneity I(x), and a specimen profile, i.e., the microscopic sample information S(x) as follows:

$$C ( x \vert m , v ) = {I}_{v} ( x ) {S}_{v} ( x - m )$$

Herein, x is again two-dimensional vector denoting detector coordinates in a suitable frame of reference. Typically, the origin is in the center of a camera chip and m is the two-dimensional translation vector describing the lateral shift the sample 2 experiences by translation by the mechanical drive 44. The goal is to estimate the field inhomogeneity, i.e., presently the pattern of structured illumination light Iᵥ(x), and the microscopic sample information Sᵥ(x) from a sequence of measurement data, e.g., a sequence of camera images for a set of variable translation vectors m.

The control unit 90 can be configured for carrying out the evaluation step as an iterative solution of a double-blind estimation problem based upon an initial estimate of the field inhomogeneity Iᵥ(x) and an initial estimate of the microscopic sample information Sᵥ(x). More specifically, the control unit can be further configured to carry out the evaluation step as a minimization of a mathematical distance between the measurement data C(x|m, v) and a combination of the field inhomogeneity Iᵥ (x) and the microscopic sample information Sᵥ(x), wherein the mathematical distance is based on an arbitrary mathematical norm.

Still more specifically, the control unit can be further configured to find the estimates of the field inhomogeneity I(x), i.e., presently the pattern of structured illumination light Iᵥ(x), and the microscopic sample information Sᵥ(x) based on the minimization of scalar cost functions L₁, L₂:

$${L}_{1} = \frac{1}{2} {\sum }_{x} {\sum }_{m} {[ ( {I}_{v} ( x ) {S}_{v} ( x - m ) - C ( x \vert m , v ) ]}^{2} + \frac{{μ}_{1}}{2} {\sum }_{x} {{I}_{v} ( x )}^{2}$$

$${L}_{2} = \frac{1}{2} {\sum }_{x} {\sum }_{m} {[ {I}_{v} ( x + m ) {S}_{v} ( x ) - C ( x + m \vert m , v ) ]}^{2} + \frac{{μ}_{2}}{2} {\sum }_{x} {{S}_{v} ( x )}^{2}$$

The (n+1)th updated estimate of the illumination pattern can then be calculated as follows:

$${I}_{v , n + 1} ( x ) = \frac{{\sum }_{m} {S}_{v , n} ( x - m ) C ( x \vert m , v )}{{\sum }_{m} {{S}_{v , n} ( x - m )}^{2} + {μ}_{1}}$$

and that the (n+1)th updated estimate of the microscopic sample information is calculated as follows:

$${S}_{v , n + 1} ( x ) = \frac{{\sum }_{m} {I}_{v , n} ( x + m ) C ( x + m \vert m , v )}{{\sum }_{m} {{I}_{v , n} ( x + m )}^{2} + {μ}_{2}}$$

wherein
C(x|m, v) are the measurement data
I_{v,n+1}(x) is (n+1)th updated estimate of the pattern of structured illumination light Iᵥ
Iᵥ(x) is the pattern of structured illumination light Iᵥ
I_{v,n}(x) is the nth updated estimate of illumination pattern Iᵥ
Sᵥ(x) is the microscopic sample information
S_{v,n}(x) is the nth updated estimate of microscopic sample information Sᵥ(x)
S_{v,n+1}(x) is the (n+1)th updated estimate of microscopic sample information
m is a two-dimensional vector in x₁, x₂-plane
x is a two-dimensional vector in the x₁, x₂-plane
wherein the summations over x are taken over all points in the respective tile, the summations over m are taken over specific relative lateral positions m and wherein μ₁ and μ₂ are non-zero scalars to prevent division by zero.

The method presented here was tested with a mouse liver specimen. The specimen was illuminated with a variable line grating for which a traditional SIM analysis would fail. It could be seen that, similar to traditional SIM, the illumination modulation contrast vanishes in the out-of-focus regions. These out-of-focus regions show little variation upon specimen translation. The resulting image is optically sectioned, i.e., out-of-focus signal is rejected.

In another experimental setup, the mouse liver specimen was translated against a stationary, i.e., fixed, structured illumination. In this particular experiment, a variable line space (VLS) grating was employed for which a traditional SIM analysis would fail since the illumination profile is not homogeneous upon translation of the specimen and averaging.

The experiment was repeated on the same mouse liver specimen and the sectioning capability upon specimen defocus was investigated. In both cases, optically sectioned images could be produced using the method described here.

In a further test the inventors could demonstrate that arbitrary patterns can be used for the method according to the invention. More specifically, an aperiodic illumination modulation was used to illuminate the same mouse liver specimen as previously discussed. It could be seen that the overall appearance of the specimen is sharper as out-of-focus signal is rejected over the entire field of view.

Here, a novel method has been described that can be termed non-uniform structured illumination microscopy (nuSIM) to achieve optical sectioning in a wide field microscope with non-uniform illumination. Unlike existing methods such as structured illumination microscopy (SIM), the technique presented here enables the use of arbitrary illumination patterns. This results in several advantages over traditional SIM:

The method described herein
1) mitigates field inhomogeneities such as dust particles on the structuring mask as well as shading in the illumination profile. It can therefore be used both as a calibration and maintenance tool and mitigates field inhomogeneities even in traditional SIM systems;
2) reduces the hardware cost of optical sectioning as compared to current implementations. The presented method is especially suited to whole slide scanning applications, where the specimen is translated through a structured illumination pattern.
3) multi-functional masks can be employed to achieve additional functionality such as on-the-fly autofocus or variable line pitch.

### LIST OF REFERENCE NUMBERS

1 sample space
2 sample
10 light source. e.g., LED
11 sample plane, observed plane in sample 2
12 illumination light, excitation light
13 structured illumination light 12, structured excitation light 12
16 emission light emitted by the sample 2
17 speck of dust, e.g., on detector 50
18 intermediate image plane, optically conjugate to sample plane 11
19 vignetting
20 tube lens in excitation beam path
22 tube lens in detection beam path, optionally tunable lens
23 main beam splitter
26 light manipulation device, transmission grating, optionally movable the directions of the optical axis and/or perpendicular to the optical axis
27 two-dimensional barcode
30 field of view of detection beam path
40 microscope objective
41 optical axis of microscope objective 40
42 back focal plane, pupil plane
44 mechanical drive for lateral manipulations, more specifically for setting a relative lateral position (x₁, x₂) between the sample 2 and the microscope objective 40 with respect to an optical axis 41 of the microscope objective 40
46 mechanical drive for axial manipulations, more specifically for setting a specified axial distance x₃ between sample 2 and microscope objective 40, controllably by control unit 90
50 detector, e.g., camera
51 detection plane, optically conjugate to sample plane 11
60 stitched image comprising 6 image tiles
61-66 image tiles
67 image tile
71-78 image tiles
80 stitched image comprising 80 image tiles
81 unit of triangular grid
90 control unit, e.g., PC
100 microscope according to the invention
a overlap in the in the x₁-direction
b overlap in the in the x₂-direction
c size of scan step
C(x−mₖ) measurement data collected for the lateral position mₖ between sample 2 and microscope objective 40 with respect to optical axis 41 of the microscope objective 40 and thus for sample illumination pattern Jₖ
C(x|m,v) measurement data collected from the detector 50 while the sample 2 is at relative lateral positions m with respect to the optical axis 41 of the microscope objective 40 and being illuminated with pattern of structured illumination light Iᵥ

$${C}_{k} = {C}_{k} ( x ) = {C}_{k} ( {x}_{1} , {x}_{2} )$$

measurement data collected from the detector 50 when the sample 2 or the second sample is subjected to sample illumination pattern Jₖ
D distance metric for scalar functions of (x₁, x₂)

$$I ( x ) = I ( {x}_{1} , {x}_{2} )$$

field inhomogeneity, can be or comprise a pattern of structured illumination light Iᵥ
I₀(x) initial estimate of field inhomogeneity I(x)
I₁(x) first updated estimate of field inhomogeneity I(x)
Iₙ(x) nth updated estimate of field inhomogeneity I(x)
Iₙ₊₁(x) (n+1)th updated estimate of field inhomogeneity I(x)

$${J}_{k} = {J}_{k} ( x ) = {J}_{k} ( {x}_{1} , {x}_{2} )$$

kth sample illumination pattern, corresponds to a pattern of structured illumination light Iᵥ in its spatial relation to the sample 2
I_{v,0}(x) initial estimate of the pattern of structured illumination light Iᵥ
I_{v,1}(x) first updated estimate of the pattern of structured illumination light Iᵥ
I_{v,n}(x) most recent or nth estimate of the pattern of structured illumination light Iᵥ
I_{v,n+1}(x) new or (n+1)th updated estimate of the pattern of structured illumination light Iᵥ
k sample illumination pattern index
K sample illumination pattern index of most recently applied sample illumination pattern J_{K}
L scalar cost function
L₁ first scalar cost function
L₂ second scalar cost function
m two-dimensional vector in x₁, x₂-plane, relative lateral positions between sample 2 and microscope objective 40 with respect to the optical axis 41 of the microscope objective 40
m₁ component of m in the x₁-direction
m₂ component of m in the x₂-direction
mₖ two-dimensional vector in x₁, x₂-plane, lateral positions between sample 2 and microscope objective 40 with respect to optical axis 41 of the microscope objective 40 defining a sample illumination pattern Jₖ
p positive integer

$$S = S ( x ) = S ( {x}_{1} , {x}_{2} )$$

microscopic sample information, sectioned microscopic sample information
S(x−mₖ) is the contribution of the microscopic sample information obtained at the lateral position mₖ and thus for sample illumination pattern Jₖ
S₀(x) initial estimate of microscopic sample information S(x)
S₁(x) first updated estimate of microscopic sample information S(x)
Sₙ(x) nth updated estimate of microscopic sample information S(x)
Sₙ₊₁(x)) (n+1)th updated estimate of microscopic sample information S(x)
Sᵥ=Sᵥ(x) microscopic sample information representing a portion of the measurement data C(x|m, v) caused by the sample or the second sample while the sample or the second sample is illuminated with the vth pattern of structured illumination light Iᵥ
S_{v,0} (x) initial estimate of the microscopic sample information Sy
S_{v,1}(x) first updated estimate of the microscopic sample information Sy
S_{v,n}(x) most recent or nth estimate of the microscopic sample information Sy
S_{v,n+1}(x) new or (n+1)th updated estimate of microscopic sample information Sᵥ
t lateral size of tile
Wₖ weight mask
x two-dimensional vector in the x₁, x₂-plane
x₁, x₂ lateral coordinates, relative lateral position between sample 2 and microscope objective 40 with respect to optical axis 41 of microscope objective 40
x₁, x₂, x₃ right-handed orthogonal coordinate system
x₁ component of x in the x₁-direction
x₂ component of x in the x₂-direction
x₃ axial coordinate, direction of optical axis, axial position of an observed plane 11 in the sample 2
α non-zero scalar
μ₁ non-zero scalar
μ₂ non-zero scalar
μ₀(J) initial estimate of the mean of the illumination patterns Jₖ
μ₀(C) initial estimate of the mean of the measurement data Cₖ μ_{K}(J) updated mean of the illumination patterns Jₖ
μ_{K}(C) updated mean of the measurement data Cₖ
v index of pattern of structured illumination light, v=0, 1, 2, 3, . . .
ρ measure of statistical dispersion with respect to sample illumination pattern index k
σ the standard mean deviation
σ₀²(C) initial estimate of the variance of the measurement data Cₖ
σ₀²(J) initial estimate of the variance of the sample illumination patterns Jₖ
σ_{K}²(C) updated variance of the measurement data Cₖ
σ_{K}²(J) updated variance of the sample illumination patterns Jₖ

### REFERENCES

[1] Neil, M. A., Juškaitis, R., & Wilson, T. (1997). Method of obtaining optical sectioning by using structured light in a conventional microscope. Optics letters, 22 (24), 1905-1907.
[2] U.S. Pat. No. 3,013,467A
[3] Huisken, J., Swoger, J., Del Bene, F., Wittbrodt, J., & Stelzer, E. H. (2004). Optical sectioning deep inside live embryos by selective plane illumination microscopy. Science, 305 (5686), 1007-1009.
[4] Ventalon, C., & Mertz, J. (2005). Quasi-confocal fluorescence sectioning with dynamic speckle illumination. Optics letters, 30 (24), 3350-3352.
[5] Ventalon, C., Heintzmann, R., & Mertz, J. (2007). Dynamic speckle illumination microscopy with wavelet prefiltering. Optics letters, 32 (11), 1417-1419.
[6] Mertz, J. (2019). Introduction to optical microscopy. Cambridge University Press.
[7] Lim, D., Chu, K. K., & Mertz, J. (2008). Wide-field fluorescence sectioning with hybrid speckle and uniform-illumination microscopy. Optics letters, 33 (16), 1819-1821.
[8] https://www.olympus-lifescience.com/en/solutions-based-systems/vs200/sila/.
[9] Labouesse, Simon, Awoke Negash, Jerome Idier, Sebastien Bourguignon, Thomas Mangeat, Penghuan Liu, Anne Sentenac, and Marc Allain. “Joint reconstruction strategy for structured illumination microscopy with unknown illuminations.” IEEE Transactions on Image Processing 26, no. 5 (2017): 2480-2493.
[10] Mangeat, Thomas, Simon Labouesse, Marc Allain, Awoke Negash, Emmanuel Martin, Aude Guénolé, Renaud Poincloux et al. “Super-resolved live-cell imaging using random illumination microscopy.” Cell Reports Methods 1, no. 1 (2021).
[11] Maronna, R. A., Martin, R. D., Yohai, V. J., & Salibian-Barrera, M. (2019). Robust statistics: theory and methods (with R). John Wiley & Sons.
[12] Heintzmann, R. (2006). Structured Illumination Methods. In: Pawley, J. (eds) Handbook Of Biological Confocal Microscopy. Springer, Boston, MA. https://doi.org/10.1007/978-O-387-45524-2_13.
[13] https://en.wikipedia.org/wiki/Entropy_(information_theory).

1. Microscope comprising:
a light source for supplying illumination light,
an illumination beam path for guiding the illumination light to a sample space comprising at least one light manipulation device for generating at least one pattern of structured illumination light,
a detector for detecting emission light emitted by a sample in the sample space,
a detection beam path comprising a microscope objective for guiding the emission light to the detector and
a control unit configured for collecting and evaluating measurement data from the detector,
wherein the control unit is configured for carrying out the following steps:
a measurement data collection step wherein measurement data Cₖ are collected from the detector while the sample is sequentially illuminated with at least two different sample illumination patterns Jₖ where each sample illumination pattern Jₖ comprises one of the patterns of structured illumination light and
a sample information calculation step wherein a microscopic sample information S is calculated which minimizes or maximizes a scalar cost function L=D[ρ(Jₖ·S),σ(Cₖ)], wherein
k is a sample illumination pattern index,
Jₖ is the kth sample illumination pattern,
Cₖ are the measurement data obtained for the sample illumination pattern Jₖ,
ρ is a measure of statistical dispersion with respect to the sample illumination pattern index k, and
D is a distance metric.

2. Microscope according to claim 1,
further comprising
a mechanical drive for setting a relative lateral position between the sample and the microscope objective with respect to an optical axis of the microscope objective, wherein the control unit is configured for controlling the mechanical drive.

3. Microscope according to the claim 1,
wherein
the detector comprises at least one of
a two-dimensionally spatially resolving photodetector,
a one-dimensionally spatially resolving detector, or
a single photodetector.

4. Microscope according to claim 1,
wherein
the at least one light manipulation device is arranged in an intermediate
image plane or in the vicinity of an intermediate image plane.

5. Microscope according to claim 1,
wherein:
the light manipulation device comprises at least one controllable light manipulation element for generating different patterns of structured illumination light,
the control unit is configured for controlling the light manipulation device, and
the controllable light manipulation element comprises at least one of:
a grating which is at least laterally adjustable in the illumination beam path,
a spatial light modulator,
a digital micromirror device.

6. Microscope according to claim 5,
wherein
the control unit is configured for changing the sample illumination pattern Jₖ by changing a setting for the controllable light manipulation element.

7. Microscope according to claim 2,
wherein
the control unit is configured for changing the sample illumination pattern Jₖ by changing a setting of the mechanical drive to a changed relative lateral position, between the sample and the microscope objective with respect to an optical axis of the microscope objective.

8. Microscope according to claim 1,
wherein
when averaged over the different sample illumination patterns Jₖ, an illumination of the sample is inhomogeneous.

9. Microscope according to claim 1,
wherein
at least one of the sample illumination patterns Jₖ is an aperiodic illumination pattern.

10. Microscope according to claim 1,
wherein
at least one of the sample illumination patterns Jₖ contains a one dimensional or a two-dimensional barcode.

11. Microscope according to claim 1,
wherein
the used measure of statistical dispersion ρ is one of:
a standard mean deviation σ,
mean absolute deviation from a median,
based on an entropy calculated along a sample illumination pattern index, wherein the entropy is one of Shannon-Entropy, Jensen-Shannon-Divergence, Renyi-Entropy, Tsallis-Entropy,
one of a plurality of robust variance measures described in reference [11],
one of a plurality of variance measures contained in a plurality of equations 1 to 5, 6a, 6b, 7a, 7b in a box in a left column on page 269 of reference [12].

12. Microscope according to claim 1,
wherein
the distance metric D is based on one of a plurality of norms selected from:
Lp-norm,
L2-norm,
Manhattan-Norm,
infinity-norm,
Shannon-Entropy-norm,
Jensen-Shannon-Divergence-norm,
Renyi-Entropy-norm,
Tsallis-Entropy-norm.

13. Microscope according to claim 1,
wherein
the control unit is configured for using, in the sample information calculation step, a cost function L=[σ(Jₖ·S)−σ(Cₖ)]², wherein σ is the standard deviation with respect to the sample illumination pattern index k, and for calculating the microscopic sample information S as
$$S = σ ( {C}_{k} ) / σ ( {J}_{k} ) .$$

14. Microscope according to claim 2,
wherein
the control unit is configured for sequentially changing the sample illumination pattern Jₖ by sequentially setting the mechanical drive to specific relative lateral positions between the sample and the microscope objective with respect to an optical axis of the microscope objective and for calculating, in the sample information calculation step,
$$σ ( {C}_{k} ) = β \cdot {( {\sum }_{k} {W}_{k} ( x - {m}_{k} ) {( C ( x - {m}_{k} ) - {μ}_{data} ( x ) )}^{2} )}^{1 / 2}$$
$$and$$
$$σ ( {I}_{k} ) = β \cdot {( {\sum }_{k} {W}_{k} ( x - {m}_{k} ) {( S ( x - {m}_{k} ) - {μ}_{i l l u} ( x ) )}^{2} )}^{1 / 2}$$
wherein
Wₖ is a weight mask that is 1 inside a window in which the sample is illuminated with the kth sample illumination pattern Jₖ and 0 elsewhere,
$${β}^{2} = 1 / ( {\sum }_{k} {{W}_{k} ( x - {m}_{k} )}^{2} + α ) ,$$
$${μ}_{data} ( x ) = {β}^{2} \cdot {\sum }_{k} {W}_{k} ( x - {m}_{k} ) C ( x - {m}_{k} ) ,$$
$${μ}_{illu} ( x ) = {β}^{2} \cdot {\sum }_{k} {W}_{k} ( x - {m}_{k} ) S ( x - {m}_{k} ) ,$$
mₖ is a lateral shift of the sample needed to expose the sample to the kth sample illumination pattern Jₖ, and
α is a non-zero scalar,
and using the calculated σ(Cₖ) and σ(Jₖ) for calculating S=σ(Cₖ)/σ(Jₖ).

15. Microscope according to claim 1,
wherein
the control unit is further configured for recursively calculating a mean and a variance of each of the measurement data Cₖ and the sample illumination patterns Jₖ with respect to the sample illumination pattern index k by calculating an updated mean and an updated variance of the measurement data Cₖ and the sample illumination patterns Jₖ, respectively, based on a previously calculated mean and a previously calculated variance of the measurement data Cₖ and the illumination Jₖ, respectively, and a most recently applied sample illumination pattern J_{K} and most recently measurement data C_{K} obtained for the most recently applied sample illumination pattern J_{K}.

16. Microscope according to claim 15,
wherein
the control unit is further configured
for calculating the updated mean μ_{K}(C) and the updated variance
$${σ}_{K}^{2} ( C )$$
of the measurement data Cₖ as:
$${μ}_{K} ( C ) = \frac{1}{K} [ ( K - 1 ) {μ}_{K - 1} ( C ) + {C}_{K} ]$$
$${σ}_{K}^{2} ( C ) = \frac{1}{K - 1} [ ( K - 2 ) {σ}_{K - 1}^{2} ( C ) + \frac{K}{K - 1} {( {μ}_{K} ( C ) - {C}_{K} )}^{2} ]$$
and for calculating the updated mean μ_{K}(J) and the updated variance
$${σ}_{K}^{2} ( J )$$
of the sample illumination patterns Jₖ as:
$${μ}_{K} ( J ) = \frac{1}{K} [ ( K - 1 ) {μ}_{K - 1} ( J ) + {J}_{K} ]$$
$${σ}_{K}^{2} ( J ) = \frac{1}{K - 1} [ ( K - 2 ) {σ}_{K - 1}^{2} ( J ) + \frac{K}{K - 1} {( {μ}_{K} ( J ) - {J}_{K} )}^{2} ]$$
wherein
K is the sample illumination pattern index of the most recently applied sample illumination pattern J_{K}.

17. Microscope according to claim 15,
wherein
the control unit is further configured for calculating
the updated mean μ_{K}(C) and the updated variance
$${σ}_{K}^{2} ( C )$$
of the measurement data as:
$${μ}_{K} ( C ) = \frac{1}{{γ}_{K}} \cdot ( {γ}_{K - 1} \cdot {μ}_{K - 1} ( C ) + {W}_{K} \cdot {C}_{K} )$$
$${σ}_{K}^{2} ( C ) = \frac{1}{{γ}_{K}} \cdot ( {γ}_{K - 1} \cdot {σ}_{K - 1}^{2} ( C ) + {{W}_{K} ( {μ}_{K} ( C ) - {C}_{K} )}^{2} )$$
and the updated mean μ_{K}(J) and the updated variance σ_{K}²(J) of the sample illumination patterns Jₖ as:
$${μ}_{K} ( J ) = \frac{1}{{γ}_{K}} \cdot ( {γ}_{K - 1} \cdot {μ}_{K - 1} ( J ) + {W}_{K} \cdot {J}_{K} )$$
$${σ}_{K}^{2} ( J ) = \frac{1}{{γ}_{K}} \cdot ( {γ}_{K - 1} \cdot {σ}_{K - 1}^{2} ( J ) + {{W}_{K} ( {μ}_{K} ( J ) - {J}_{K} )}^{2} )$$
$$wherein {γ}_{K} = {\sum }_{k = 1}^{K} {W}_{k}^{2}$$
Wₖ is a weight mask that is 1 inside a window in which the sample was illuminated with the kth sample illumination pattern Jₖ and 0 elsewhere, and using the calculated updated variance
$${σ}_{K}^{2} ( C )$$
of the measurement data Cₖ and the calculated updated variance
$${σ}_{K}^{2} ( J )$$
of the sample illumination patterns Jₖ for calculating an updated estimate SK of the microscopic sample information as
$${S}_{K} = \sqrt{{σ}_{K}^{2} ( C ) / {σ}_{K}^{2} ( J )} .$$

18. Microscope according to claim 16,
wherein
the control unit is further configured for using as initial estimates
$${μ}_{0} ( J ) = {J}_{1} , {μ}_{0} ( C ) = {C}_{1} , {σ}_{0}^{2} ( J ) = 0 , and {σ}_{0}^{2} ( C ) = 0 .$$

19. Microscope according to claim 1,
wherein
the control unit is configured for determining at least one of the patterns of structured illumination light prior to the measurement data collection step or as a part of the measurement data collection step and prior to the sample information calculation step.

20. Microscope according to claim 1,
wherein
the control unit is configured for determining a pattern of structured illumination light as a field inhomogeneity in a field of view of the microscope according to one of a plurality of methods for determining a field inhomogeneity in a field of view of a microscope described in German patent application 10 2024 124 248.5.

21. Microscope according to claim 2,
wherein
for determining a pattern of structured illumination light, the control unit is configured for carrying out the following steps:
a) a setting step wherein the mechanical drive is sequentially set to at least three different relative lateral positions while the sample or a second sample is illuminated with the respective pattern of structured illumination light,
b) a collecting step, wherein, in the different relative lateral positions measurement data are collected from the detector at least for a subset of points in the sample or the second sample in a field of view of the detection beam path, wherein for each of the points in the subset measurement data are collected for at least two different lateral positions of the mechanical drive while the sample or a second sample is illuminated with the pattern of structured illumination light,
c) an evaluation step wherein, based upon the measurement data collected in the collecting step, the following steps are carried out:
c1) extracting from the measurement data the pattern of structured illumination light in the field of view used in steps a) and b) and using the assumption that the pattern of structured illumination light is not dependent of the respectively set relative lateral position and
c2) extracting from the measurement data a sample information representing a portion of the measurement data caused by the sample used in steps a) and b).

22. Microscope according to claim 21,
wherein
the control unit is further configured in that the two-dimensional grid of set relative lateral positions is configured in such a way that an overlap between neighboring tiles is at least 50% in a first coordinate direction and that an overlap between neighboring tiles is at least 5% and preferably at least 10% in a second coordinate direction.

23. Microscope according to claim 21,
wherein
the control unit is configured for carrying out at least some or all of the following steps in the evaluation step:
calculating an estimate of the microscopic sample information based on the measurement data and using an initial estimate of the pattern of structured illumination light
iteratively calculating
updated estimates of the pattern of structured illumination light based on the measurement data and using in each case a most recent estimate of the microscopic sample information and
updated estimates of the microscopic sample information based on the measurement data and using in each case a most recent estimate of the pattern of structured illumination light,
evaluating an accuracy level to which the most recent estimate of the pattern of structured illumination light and the most recent estimate of the microscopic sample information reproduce the measurement data,
repeating the step of iteratively calculating updated estimates of the pattern of structured illumination light and updated estimates of the microscopic sample information until the measurement data are reproduced by the most recent estimate of the pattern of structured illumination light and the most recent estimate of the microscopic sample information to a specified level of accuracy.

24. Microscope according to claim 21,
wherein
the control unit is further configured to carry out the evaluation step as a minimization of a mathematical distance between the measurement data and a combination of the pattern of structured illumination light and the microscopic sample information, wherein the mathematical distance is based on an arbitrary mathematical norm.

25. Microscope according to claim 21,
wherein
the control unit is further configured to carry out the following steps in the evaluation step:
taking a new estimate of the pattern of structured illumination light as a new updated estimate of the pattern of structured illumination light and a new estimate of the microscopic sample information as a new updated estimate of the microscopic sample information
if the value of a first scalar cost function for the new estimate of the pattern of structured illumination light and the new estimate of the microscopic sample information is smaller than the value of the first scalar cost function for the most recent updated estimate of the pattern of structured illumination light and the most recent updated estimate of the microscopic sample information and
if the value of a second scalar cost function for the new estimate of the pattern of structured illumination light and the new estimate of the microscopic sample information is smaller than the value of the second scalar cost function for the most recent updated estimate of the pattern of structured illumination light and the most recent updated estimate of the microscopic sample information,
wherein the first scalar cost function and the second scalar cost function in each case contain a mathematical distance between the measurement data and a combination of the pattern of structured illumination light with the microscopic sample information and
wherein the first scalar cost function contains the norm of the pattern of structured illumination light and the second scalar cost function contains the mathematical norm of the microscopic sample information.

26. Microscope according to claim 25,
wherein
the first cost function (L₁) and the second cost function (L₂) are respectively given by
$${L}_{1} = \frac{1}{2} {\sum }_{x} {{\sum }_{m} [ ( {I}_{v} ( x ) {S}_{v} ( x - m ) - C ( x \vert m , v ) ]}^{2} + \frac{{μ}_{1}}{2} {\sum }_{x} {{I}_{v} ( x )}^{2}$$
$${L}_{2} = \frac{1}{2} {\sum }_{x} {{\sum }_{m} [ {I}_{v} ( x + m ) {S}_{v} ( x ) - C ( x + m \vert m , v ) ]}^{2} + \frac{{μ}_{2}}{2} {\sum }_{x} {{S}_{v} ( x )}^{2}$$
and wherein
the (n+1)th updated estimate of the pattern of structured illumination light is calculated as follows:
$${I}_{v , n + 1} ( x ) = \frac{{\sum }_{m} {S}_{v , n} ( x - m ) C ( x \vert m , v )}{{\sum }_{m} {{S}_{v ,} ( x - m )}^{2} + {μ}_{1}}$$
and the (n+1)th updated estimate of the microscopic sample information is calculated as follows:
$${S}_{v , n + 1} ( x ) = \frac{{\sum }_{m} {I}_{v , n} ( x + m ) C ( x + m \vert m , v )}{{\sum }_{m} {{I}_{v , n} ( x + m )}^{2} + {μ}_{2}}$$
wherein
C(x|m, v) are the measurement data,
Iᵥ(x) is the pattern of structured illumination light,
I_{v,n}(x) is the nth updated estimate of the pattern of structured illumination light Iᵥ,
I_{v,n+1}(x) is (n+1)th updated estimate of pattern of structured illumination light Iᵥ,
Sᵥ(x) is the microscopic sample information,
S_{v,n}(x) is the nth updated estimate of microscopic sample information Sᵥ,
S_{v,n+1}(x) is the (n+1)th updated estimate of microscopic sample information Sᵥ,
μ₁ and μ₂ are non-zero scalars,
m is a two-dimensional vector in x₁, x₂-plane,
x is a two-dimensional vector in the x₁, x₂-plane.

27. Microscope according to claim 1,
further comprising
an axial drive for setting a specified axial distance between the sample and the microscope objective wherein the control unit is configured for controlling the axial drive.

28. Microscope according to claim 1,
wherein
at least one of the detection beam path or the illumination beam path comprises at least one variable optical component for changing an axial position of an observed plane in the sample.

29. Microscopy method comprising the following steps:
illuminating a sample through an illumination beam path of a microscope with structured illumination light,
guiding emission light emitted by the sample through a detection beam path comprising a microscope objective to a detector,
detecting the emission light with the detector,
further comprising
a measurement data collection step wherein measurement data Cₖ are collected from the detector while the sample is sequentially illuminated with at least two different sample illumination patterns Jₖ and
a sample information calculation step wherein a microscopic sample information S is calculated which minimizes or maximizes a scalar cost function L=D[ρ(Jₖ·S),ρ(Cₖ)],
wherein
k is a sample illumination pattern index,
J_{K} is the kth sample illumination pattern,
Cₖ is the detector signal obtained for the sample illumination pattern Jₖ,
ρ is a measure of statistical dispersion with respect to the sample illumination pattern index k, and
D is a distance metric.

30. (canceled)
